(19) United States
(12) Patent Application Publication
(10) Pub. No.: US 2021/0058996 A1
(43) Pub. Date: Feb. 25, 2021

(54) METHOD FOR TRANSCEIVING A SIGNAL AND WIRELESS TERMINAL THEREOF

(71) Applicant: LG Electronics Inc., Seoul (KR)

(72) Inventors: Yoonoh YANG, Seoul (KR); Sangwook LEE, Seoul (KR); Suhwan LIM, Seoul (KR); Manyoung JUNG, Seoul (KR); Jinyup HWANG, Seoul (KR)

(21) Appl. No.: 16/962,936

(22) PCT Filed: Feb. 7, 2019
(86) PCT No.: PCT/KR2019/001528

§ 371 Date: Jul. 17, 2020

Related U.S. Application Data
(60) Provisional application No. 62/629,668, filed on Feb. 12, 2018.

(30) Foreign Application Priority Data
Mar. 29, 2018 (KR) 10-2018-0036215

(51) Int. Cl. H04W 76/16; H04W 56/00; H04L 5/00; H04W 24/10

(52) U.S. Cl. CPC H04W 76/16; H04W 24/10; H04L 5/0094; H04W 56/001

(57) ABSTRACT

A disclosure of the present specification provides a method for transceiving a signal. The method may be performed by a user equipment (UE) and comprise: transmitting uplink signals to a first cell and a second cell. The first cell and the second cell may be configured for a dual connectivity. The first cell may be an evolved universal terrestrial radio access (E-UTRA) based cell. The second cell may be a new radio access technology (NR) based cell. The method may comprise: determining that a maximum transmission timing difference (MTTD) between the first cell and the second cell is 35.21 μs for all of uplink subcarrier spacings (SCSs) of the second cell. The all of the uplink SCSs of the second cell may include 15 kHz, 30 kHz, 60 kHz and 120 kHz.

### BACKGROUND OF THE DISCLOSURE

### Field of the Disclosure

The present invention relates to mobile communication.

### Related Art

With the success of Evolved Universal Terrestrial Radio Access Network (E-UTRAN) for the fourth-generation mobile communication which is Long Term Evolution (LTE)/LTE-Advanced (LTE-A), the next generation mobile communication, which is the fifth-generation (so called 5G) mobile communication, has been attracting attentions and more and more researches are being conducted.

For the fifth-generation (so called 5G) mobile communication, a new radio access technology (New RAT or NR) have been studied and researched.

An NR cell may operate not just in standalone deployment (SA), but also in a non-standalone deployment (NSA). According to the NSA deployment, a UE may be connected in dual connectivity (DC) with an E-UTRAN (that is, LTE/LTE-A) cell and the NR cell. This type of dual connectivity is called EN-DC.

However, until now, a maximum receive timing difference (MRTD) and a maximum transmission timing difference (MTTD) for EN-DC case have not been researched.

### SUMMARY OF THE DISCLOSURE

### Technical Objects

Accordingly, a disclosure of the present specification has been made in an effort to solve the aforementioned problem.

### Technical Solutions

Accordingly, in an effort to solve the aforementioned problem, a disclosure of the present specification provides a method for transceiving a signal. The method may be performed by a user equipment (UE) and comprise: transmitting uplink signals to a first cell and a second cell. The first cell and the second cell may be configured for a dual connectivity. The first cell may be an evolved universal terrestrial radio access (E-UTRA) based cell. The second cell may be a new radio access technology (NR) based cell. The method may comprise: determining that a maximum transmission timing difference (MTTD) between the first cell and the second cell is 35.21 μs for all of uplink subcarrier spacings (SCSs) of the second cell. The all of the uplink SCSs of the second cell may include 15 kHz, 30 kHz, 60 kHz and 120 kHz.

The method may further comprise: handling the MTTD of 35.21 μs.

The method may further comprise: receiving downlink signals from the first cell and the second cell; and determining that a maximum receive timing difference (MRTD) between the first cell and the second cell is 33 μs for all of downlink SCSs of the second cell. The all of the downlink SCSs of the second cell may include 15 kHz, 30 kHz, 60 kHz and 120 kHz.

The method may further comprise: handling the MRTD of 33 μs.

The EN-DC may be an inter-band EN-DC.

The EN-DC may be a synchronous EN-DC.

Accordingly, in an effort to solve the aforementioned problem, a disclosure of the present specification provides a wireless terminal for transceiving a signal. The wireless terminal may comprise: a transceiver which transmits uplink signals to a first cell and a second cell. The first cell and the second cell may be configured for a dual connectivity. The first cell may be an evolved universal terrestrial radio access (E-UTRA) based cell. The second cell may be a new radio access technology (NR) based cell. The UE may comprise: a processor operatively connected to the transceiver and configured to determine that a maximum transmission timing difference (MTTD) between the first cell and the second cell is 35.21 μs for all of uplink subcarrier spacings (SCSs) of the second cell. The all of the uplink SCSs of the second cell may include 15 kHz, 30 kHz, 60 kHz and 120 kHz.

In an effort to solve the aforementioned problem, a disclosure of the present specification provides a controller for a wireless terminal. The controller may comprise: a processor configured to transmit, via a transceiver, uplink signals to a first cell and a second cell. The first cell and the second cell may be configured for a dual connectivity. The first cell may be an evolved universal terrestrial radio access (E-UTRA) based cell. The second cell may be a new radio access technology (NR) based cell. The processor may be configured to determine that a maximum transmission timing difference (MTTD) between the first cell and the second cell is 35.21 μs for all of uplink subcarrier spacings (SCSs) of the second cell. The all of the uplink SCSs of the second cell may include 15 kHz, 30 kHz, 60 kHz and 120 kHz.

### Effects of the Disclosure

According to the disclosure of the present invention, the problem of the conventional technology described above may be solved.

### BRIEF DESCRIPTION OF THE DRAWINGS

FIG. 1 is a wireless communication system.

FIG. 2 illustrates a structure of a radio frame according to FDD in 3GPP LTE.

FIG. 3 illustrates a procedure for cell detection and measurement.

FIGS. 4A to 4C are diagrams illustrating exemplary architecture for a service of the next-generation mobile communication.

FIG. 5 illustrates an example of a subframe type in NR.

FIG. 6 illustrates an example of an SS block in NR.

FIG. 7 illustrates an example of beam sweeping in NR.

FIG. 8 illustrates an example of performing measurement in an EN (E-UTRAN and NR)-DC case.

FIG. 9 shows an example of deployment of EN-DC

FIG. 10a shows an example case of MTTD<=Tthr, FIG. 10b shows an example case of MTTD>Tthr and FIG. 10c shows an example case of MTTD>Tthr and MTTD<=Tthr.

FIG. 11 is a block diagram illustrating a wireless device and a base station, by which a disclosure of this specification is implemented.

FIG. 12 is a detailed block diagram of a transceiver of the wireless device shown in FIG. 11.

### DESCRIPTION OF EXEMPLARY EMBODIMENTS

The technical terms used herein are used to merely describe specific embodiments and should not be construed as limiting the present invention. Further, the technical terms used herein should be, unless defined otherwise, interpreted as having meanings generally understood by those skilled in the art but not too broadly or too narrowly. Further, the technical terms used herein, which are determined not to exactly represent the spirit of the invention, should be replaced by or understood by such technical terms as being able to be exactly understood by those skilled in the art. Further, the general terms used herein should be interpreted in the context as defined in the dictionary, but not in an excessively narrowed manner.

The expression of the singular number in the present invention includes the meaning of the plural number unless the meaning of the singular number is definitely different from that of the plural number in the context. In the following description, the term ‘include’ or ‘have’ may represent the existence of a feature, a number, a step, an operation, a component, a part or the combination thereof described in the present invention, and may not exclude the existence or addition of another feature, another number, another step, another operation, another component, another part or the combination thereof.

The terms ‘first’ and ‘second’ are used for the purpose of explanation about various components, and the components are not limited to the terms ‘first’ and ‘second’. The terms ‘first’ and ‘second’ are only used to distinguish one component from another component. For example, a first component may be named as a second component without deviating from the scope of the present invention.

It will be understood that when an element or layer is referred to as being “connected to” or “coupled to” another element or layer, it can be directly connected or coupled to the other element or layer or intervening elements or layers may be present. In contrast, when an element is referred to as being “directly connected to” or “directly coupled to” another element or layer, there are no intervening elements or layers present.

Hereinafter, exemplary embodiments of the present invention will be described in greater detail with reference to the accompanying drawings. In describing the present invention, for ease of understanding, the same reference numerals are used to denote the same components throughout the drawings, and repetitive description on the same components will be omitted. Detailed description on well-known arts which are determined to make the gist of the invention unclear will be omitted. The accompanying drawings are provided to merely make the spirit of the invention readily understood, but not should be intended to be limiting of the invention. It should be understood that the spirit of the invention may be expanded to its modifications, replacements or equivalents in addition to what is shown in the drawings.

As used herein, ‘base station’ generally refers to a fixed station that communicates with a wireless device and may be denoted by other terms such as eNB (evolved-NodeB), BTS (base transceiver system), or access point.

As used herein, ‘user equipment (UE)’ may be stationary or mobile, and may be denoted by other terms such as device, wireless device, terminal, MS (mobile station), UT (user terminal), SS (subscriber station), MT (mobile terminal) and etc.

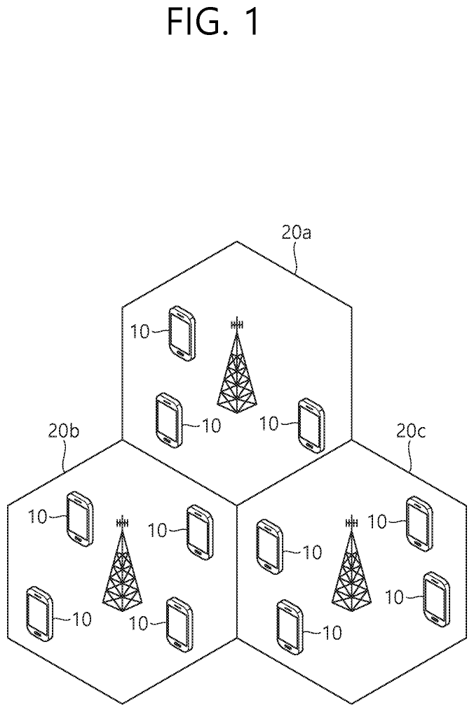

FIG. 1 Illustrates a Wireless Communication System.

As seen with reference to FIG. 1, the wireless communication system includes at least one base station (BS) 20. Each base station 20 provides a communication service to specific geographical areas (generally, referred to as cells) 20a, 20b, and 20c. The cell can be further divided into a plurality of areas (sectors).

The UE generally belongs to one cell and the cell to which the UE belong is referred to as a serving cell. A base station that provides the communication service to the serving cell is referred to as a serving BS. Since the wireless communication system is a cellular system, another cell that neighbors to the serving cell is present. Another cell which neighbors to the serving cell is referred to a neighbor cell. A base station that provides the communication service to the neighbor cell is referred to as a neighbor BS. The serving cell and the neighbor cell are relatively decided based on the UE.

Hereinafter, a downlink means communication from the base station 20 to the UE1 10 and an uplink means communication from the UE 10 to the base station 20. In the downlink, a transmitter may be a part of the base station 20 and a receiver may be a part of the UE 10. In the uplink, the transmitter may be a part of the UE 10 and the receiver may be a part of the base station 20.

Meanwhile, the wireless communication system may be generally divided into a frequency division duplex (FDD) type and a time division duplex (TDD) type. According to the FDD type, uplink transmission and downlink transmission are achieved while occupying different frequency bands. According to the TDD type, the uplink transmission and the downlink transmission are achieved at different time while occupying the same frequency band. A channel response of the TDD type is substantially reciprocal. This means that a downlink channel response and an uplink channel response are approximately the same as each other in a given frequency area. Accordingly, in the TDD based wireless communication system, the downlink channel response may be acquired from the uplink channel response. In the TDD type, since an entire frequency band is time-divided in the uplink transmission and the downlink transmission, the downlink transmission by the base station and the uplink transmission by the terminal may not be performed simultaneously. In the TDD system in which the uplink transmission and the downlink transmission are divided by the unit of a subframe, the uplink transmission and the downlink transmission are performed in different subframes.

Hereinafter, the LTE system will be described in detail.

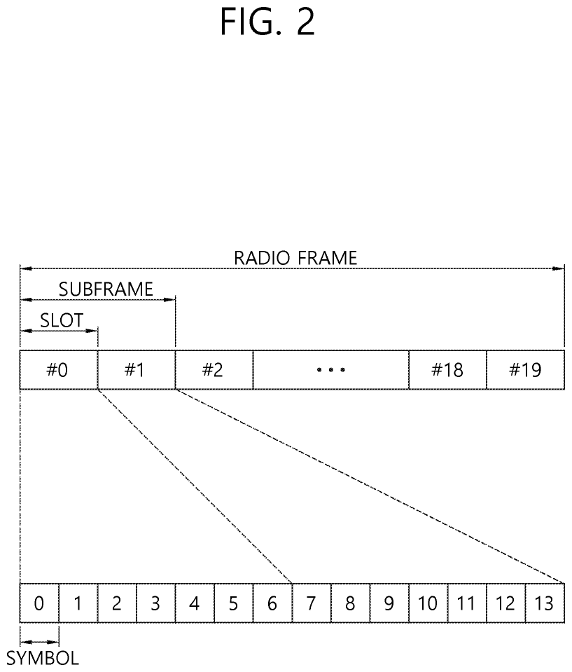

FIG. 2 Shows a Downlink Radio Frame Structure According to FDD of 3rd Generation Partnership Project (3GPP) Long Term Evolution (LTE).

The radio frame of FIG. 2 may be found in the section 5 of 3GPP TS 36.211 V10.4.0 (2011 December) “Evolved Universal Terrestrial Radio Access (E-UTRA); Physical Channels and Modulation (Release 10)”.

The radio frame includes 10 sub-frames indexed 0 to 9. One sub-frame includes two consecutive slots. Accordingly, the radio frame includes 20 slots. The time taken for one sub-frame to be transmitted is denoted TTI (transmission time interval). For example, the length of one sub-frame may be 1 ms, and the length of one slot may be 0.5 ms.

The structure of the radio frame is for exemplary purposes only, and thus the number of sub-frames included in the radio frame or the number of slots included in the sub-frame may change variously.

One slot includes NRB resource blocks (RBs) in the frequency domain. For example, in the LTE system, the number of resource blocks (RBs), i.e., NRB, may be one from 6 to 110.

The resource block is a unit of resource allocation and includes a plurality of sub-carriers in the frequency domain. For example, if one slot includes seven OFDM symbols in the time domain and the resource block includes 12 sub-carriers in the frequency domain, one resource block may include 7×12 resource elements (REs).

The physical channels in 3GPP LTE may be classified into data channels such as PDSCH (physical downlink shared channel) and PUSCH (physical uplink shared channel) and control channels such as PDCCH (physical downlink control channel), PCFICH (physical control format indicator channel), PHICH (physical hybrid-ARQ indicator channel) and PUCCH (physical uplink control channel).

The uplink channels include a PUSCH, a PUCCH, an SRS (Sounding Reference Signal), and a PRACH (physical random access channel).

<Measurement and Measurement Report>

Supporting mobility of a UE 100 is essential in a mobile communication system. Thus, the UE 100 constantly measures a quality of a serving cell which is currently providing a service, and a quality of a neighbor cell. The UE 10 reports a result of the measurement to a network at an appropriate time, and the network provides optimal mobility to the UE through a handover or the like. Measurement for this purpose is referred to as a Radio Resource Management (RRM).

Meanwhile, the UE 100 monitors a downlink quality of a primary cell (Pcell) based on a CRS. This is so called Radio Link Monitoring (RLM).

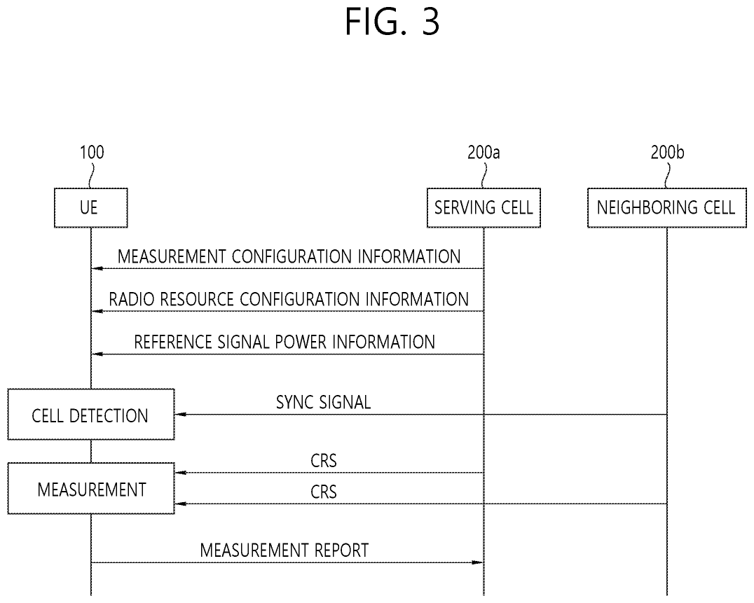

FIG. 3 Shows a Procedure for Cell Detection and Measurement.

Referring to FIG. 3, a UE detects a neighbor cell based on Synchronization Signal (SS) which is transmitted from the neighbor cell. The SS may include a Primary Synchronization Signal (PSS) and a Secondary Synchronization Signal (SSS).

When the serving cell 200a and the neighbor cell respectively transmit Cell-specific Reference Signals (CRSs), the UE 100 measures the CRSs and transmits a result of the measurement to the serving cell 200a. In this case, the UE 100 may compare power of the received CRSs based on received information on a reference signal power.

At this point, the UE 100 may perform the measurement in the following three ways.

1) RSRP (reference signal received power): This represents an average reception power of all REs that carry the CRS which is transmitted through the whole bands. In this case, instead of the CRS, an average reception power of all REs that carry the CSI RS may also be measured.

2) RSS (received signal strength indicator): This represents a reception power which is measured through the whole bands. The RSSI includes all of signal, interference and thermal noise.

3) RSRQ (reference symbol received quality): This represents a CQI, and may be determined as the RSRP/RSSI according to a measured bandwidth or a sub-band. That is, the RSRQ signifies a signal-to-noise interference ratio (SINR). Since the RSRP is unable to provide a sufficient mobility, in handover or cell reselection procedure, the RSRQ may be used instead of the RSRP.

The RSRQ may be obtained by RSSI/RS SP.

Meanwhile, the UE 100 receives a radio resource configuration information element (IE) from the serving cell 100a for the measurement. The radio resource configuration information element (IE) is used to configure/modify/cancel a radio bearer or to modify an MAC configuration. The radio resource configuration IE includes subframe pattern information. The subframe pattern information is information on a measurement resource restriction pattern on the time domain, for measuring RSRP and RSRQ of a serving cell (e.g., PCell).

Meanwhile, the UE 100 receives a measurement configuration information element (IE) from the serving cell 100a for the measurement. A message including the measurement configuration information element (IE) is called a measurement configuration message. Here, the measurement configuration information element (IE) may be received through a RRC connection reconfiguration message. If the measurement result satisfies a report condition in the measurement configuration information, the UE reports the measurement result to a base station. A message including the measurement result is called a measurement report message.

The measurement configuration IE may include measurement object information. The measurement object information is information of an object which is to be measured by the UE. The measurement object includes at least one of an intra-frequency measurement object which is an object of intra-cell measurement, an inter-frequency measurement object which is an object of inter-cell measurement and an inter-RAT measurement object which is an object of inter-RAT measurement. For example, the intra-cell measurement object indicates a neighbor cell that has a frequency band which is identical to that of a serving cell, the inter-cell measurement object indicates a neighbor cell that has a frequency band which is different from that of a serving cell, and the inter-RAT measurement object indicates a neighbor cell of a RAT which is different from that of a serving cell.

TABLE 1
Measurement object field description
carrierFreq
This indicates an E-UTRA carrier frequency to which this configuration
is applied.
measCycleSCell
This indicates a cycle for measurement of a secondary cell (SCell) in a
non-activated state. Its value may be set to 40, 160, 256, etc. If the value
is 160, it indicates that measurement is performed every 160 subframes.

Meanwhile, the measurement configuration IE includes an information element (IE) as shown in the following table.

TABLE 2
MeasConfig field description
allowInterruptions
If its value is True, it indicates that interruption of transmission and
reception with a serving cell is allowed when measurement of subcarriers
of an Scell in a non-active state is performed using MeasCycleScell.
measGapConfig
It indicates configuration or cancelation of a measurement gap.

The “measGapConfig” is used to configure or cancel a measurement gap (MG). The MG is a period for cell identification and RSRP measurement on an inter frequency different from that of a serving cell.

TABLE 3
MeasGapConfig field description
gapOffset
Any one of gp0 and gp1 may be set as a value of gapOffset. gp0
corresponds to a gapoffset of pattern ID “0” having MGRP 40 ms. gp1
corresponds to a gapoffset of pattern ID “1” having MGRP = 80 ms.

TABLE 4

| | | | Minimum available time |
|---|---|---|---|
| Gap | Measurement | Measurement Gap | for inter-frequency and |
| pattern | Gap Length | Repetition Period | inter-RAT measurements |
| Id | (MGL) | (MGRP) | during 480 ms period |
| 0 | 6 ms | 40 ms | 60 ms |
| 1 | 6 ms | 80 ms | 30 ms |

When the UE requires a measurement gap to identity and measure a cell at an inter-frequency and inter-RAT, the E-UTRAN (i.e., the base station) may provide a single measurement gap (MG) pattern with a predetermined gap period to the UE. Without transmitting or receiving any data from the serving cell for the measurement gap period, the UE retunes its RF chain to be adapted to the inter-frequency and then performs measurement at the corresponding inter-frequency.

<Carrier Aggregation>

A carrier aggregation system is now described.

A carrier aggregation system aggregates a plurality of component carriers (CCs). A meaning of an existing cell is changed according to the above carrier aggregation. According to the carrier aggregation, a cell may signify a combination of a downlink component carrier and an uplink component carrier or an independent downlink component carrier.

Further, the cell in the carrier aggregation may be classified into a primary cell, a secondary cell, and a serving cell. The primary cell signifies a cell operated in a primary frequency. The primary cell signifies a cell which UE performs an initial connection establishment procedure or a connection reestablishment procedure or a cell indicated as a primary cell in a handover procedure. The secondary cell signifies a cell operating in a secondary frequency. Once the RRC connection is established, the secondary cell is used to provided an additional radio resource.

As described above, the carrier aggregation system may support a plurality of component carriers (CCs), that is, a plurality of serving cells unlike a single carrier system.

The carrier aggregation system may support a cross-carrier scheduling. The cross-carrier scheduling is a scheduling method capable of performing resource allocation of a PDSCH transmitted through other component carrier through a PDCCH transmitted through a specific component carrier and/or resource allocation of a PUSCH transmitted through other component carrier different from a component carrier basically linked with the specific component carrier.

<Introduction of Dual Connectivity (DC)>

Recently, a scheme for simultaneously connecting UE to different base stations, for example, a macro cell base station and a small cell base station, is being studied. This is called dual connectivity (DC).

In DC, the eNodeB for the primary cell (Pcell) may be referred to as a master eNodeB (hereinafter referred to as MeNB). In addition, the eNodeB only for the secondary cell (Scell) may be referred to as a secondary eNodeB (hereinafter referred to as SeNB).

A cell group including a primary cell (Pcell) implemented by MeNB may be referred to as a master cell group (MCG) or PUCCH cell group 1. A cell group including a secondary cell (Scell) implemented by the SeNB may be referred to as a secondary cell group (SCG) or PUCCH cell group 2.

Meanwhile, among the secondary cells in the secondary cell group (SCG), a secondary cell in which the UE can transmit Uplink Control Information (UCI), or the secondary cell in which the UE can transmit a PUCCH may be referred to as a super secondary cell (Super SCell) or a primary secondary cell (Primary Scell; PScell).

<Internet of Things (IoT) Communication>

Hereinafter, IoT will be described.

The IoT communication refers to the exchange of information between an IoT devices without human interaction through a base station or between the IoT device and a server through the base station. In this way, the IoT communication is also referred to as CIoT (Cellular Internet of Things) in that the IoT communication is performed through the cellular base station.

This IoT communication is a kind of machine type communication (MTC). Therefore, the IoT device may be referred to as an MTC device.

The IoT communication has a small amount of transmitted data. Further, uplink or downlink data transmission/reception rarely occurs. Accordingly, it is desirable to lower a price of the IoT device and reduce battery consumption in accordance with the low data rate. In addition, since the IoT device has low mobility, the IoT device has substantially the unchanged channel environment.

In one approach to a low cost of the IoT device, the IoT device may use, for example, a sub-band of approximately 1.4 MHz regardless of a system bandwidth of the cell.

The IoT communication operating on such a reduced bandwidth may be called NB (Narrow Band) IoT communication or NB CIoT communication.

<Next-Generation Mobile Communication Network>

With the success of Evolved Universal Terrestrial Radio Access Network (E-UTRAN) for the fourth-generation mobile communication which is Long Term Evolution (LTE)/LTE-Advanced (LTE-A), the next generation mobile communication, which is the fifth-generation (so called 5G) mobile communication, has been attracting attentions and more and more researches are being conducted.

The fifth-generation communication defined by the International Telecommunication Union (ITU) refers to providing a maximum data transmission speed of 20 Gbps and a maximum transmission speed of 100 Mbps per user in anywhere. It is officially called “IMT-2020” and aims to be released around the world in 2020.

The ITU suggests three usage scenarios, for example, enhanced Mobile BroadBand (eMBB), massive Machine Type Communication (mMTC), and Ultra Reliable and Low Latency Communications (URLLC).

URLLC relates to a usage scenario in which high reliability and low delay time are required. For example, services like autonomous driving, automation, and virtual realities requires high reliability and low delay time (for example, 1 ms or less). A delay time of the current 4G (LTE) is statistically 21-43 ms (best 10%), 33-75 ms (median). Thus, the current 4G (LTE) is not sufficient to support a service requiring a delay time of 1 ms or less. Next, eMBB relates to a usage scenario in which an enhanced mobile broadband is required.

That is, the fifth-generation mobile communication system aims to achieve a capacity higher than the current 4G LTE and is capable of increasing a density of mobile broadband users and support Device-to-Device (D2D), high stability, and Machine Type Communication (MTC). Researches on 5G aims to achieve reduced waiting time and less batter consumption, compared to a 4G mobile communication system, in order to implement the IoT. For the 5G mobile communication, a new radio access technology (New RAT or NR) may be proposed.

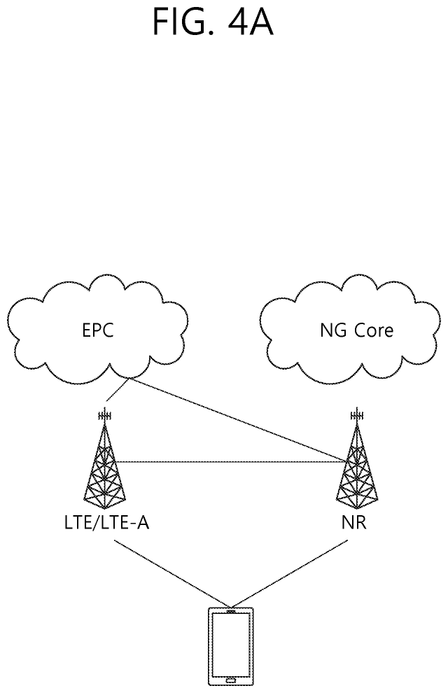

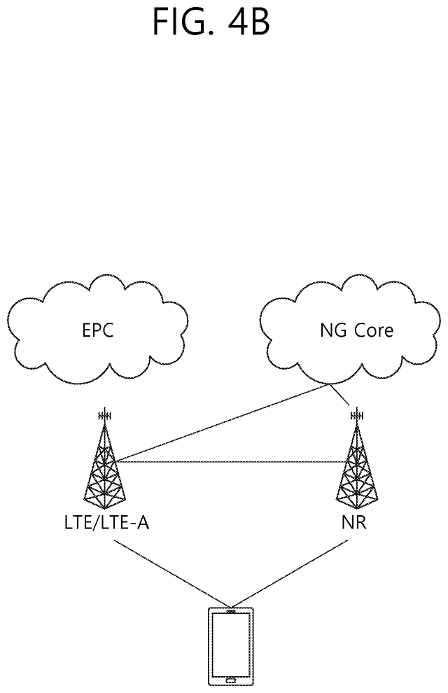

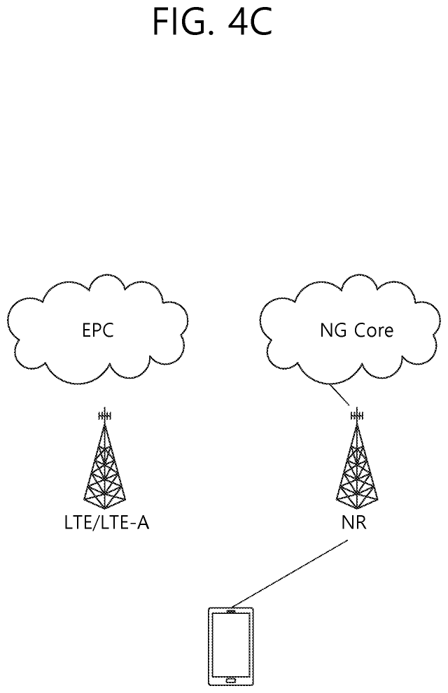

FIGS. 4A to 4C are Diagrams Illustrating Exemplary Architecture for a Next-Generation Mobile Communication Service.

Referring to FIG. 4A, a UE is connected in dual connectivity (DC) with an LTE/LTE-A cell and a NR cell.

The NR cell is connected with a core network for the legacy fourth-generation mobile communication, that is, an Evolved Packet core (EPC).

Referring to FIG. 4B, the LTE/LTE-A cell is connected with a core network for 5th generation mobile communication, that is, a Next Generation (NG) core network, unlike the example in FIG. 4A.

A service based on the architecture shown in FIGS. 4A and 4B is referred to as a non-standalone (NSA) service.

Referring to FIG. 4, a UE is connected only with an NR cell. A service based on this architecture is referred to as a standalone (SA) service.

Meanwhile, in the above new radio access technology (NR), using a downlink subframe for reception from a base station and using an uplink subframe for transmission to the base station may be considered. This method may be applied to paired spectrums and not-paired spectrums. A pair of spectrum indicates including two subcarrier for downlink and uplink operations. For example, one subcarrier in one pair of spectrum may include a pair of a downlink band and an uplink band.

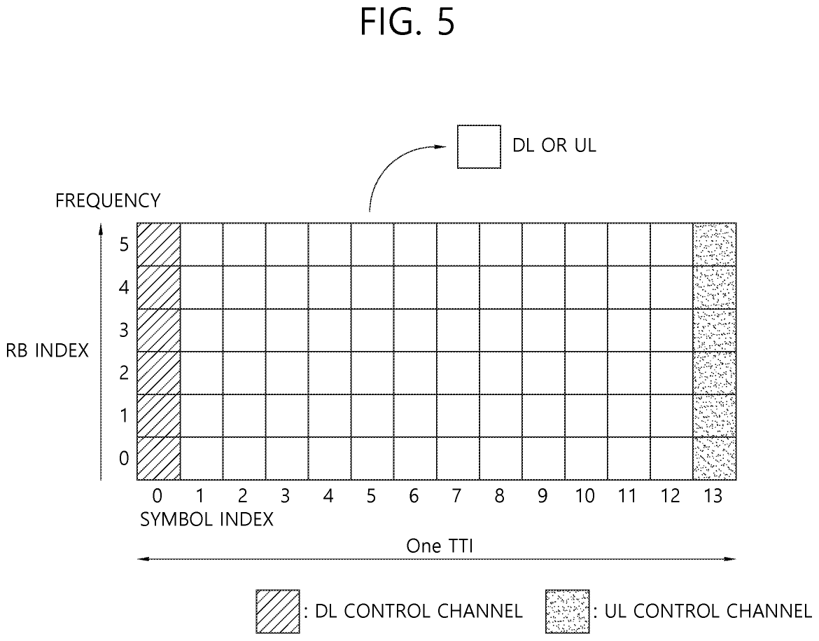

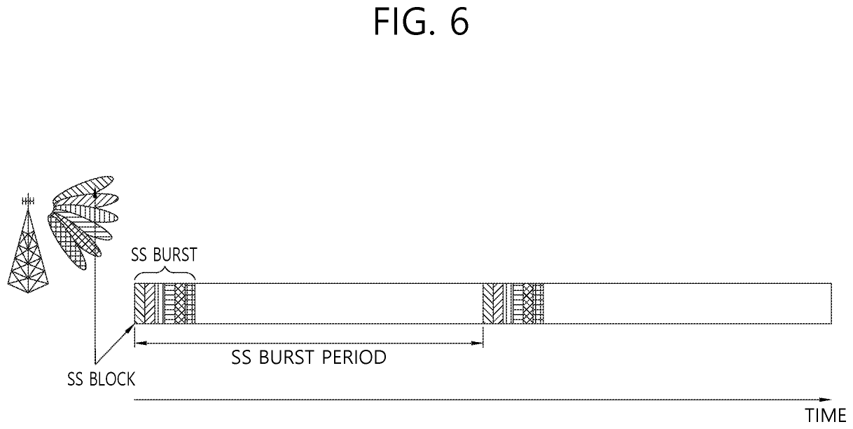

FIG. 5 Shows an Example of Subframe Type in NR.

A transmission time interval (TTI) shown in FIG. 5 may be called a subframe or slot for NR (or new RAT). The subframe (or slot) in FIG. 5 may be used in a TDD system of NR (or new RAT) to minimize data transmission delay. As shown in FIG. 4, a subframe (or slot) includes 14 symbols as does the current subframe. A front symbol of the subframe (or slot) may be used for a downlink control channel, and a rear symbol of the subframe (or slot) may be used for a uplink control channel. Other channels may be used for downlink data transmission or uplink data transmission. According to such structure of a subframe (or slot), downlink transmission and uplink transmission may be performed sequentially in one subframe (or slot). Therefore, a downlink data may be received in the subframe (or slot), and a uplink acknowledge response (ACK/NACK) may be transmitted in the subframe (or slot). A subframe (or slot) in this structure may be called a self-constrained subframe. If this structure of a subframe (or slot) is used, it may reduce time required to retransmit data regarding which a reception error occurred, and thus, a final data transmission waiting time may be minimized. In such structure of the self-contained subframe (slot), a time gap may be required for transition from a transmission mode to a reception mode or vice versa. To this end, when downlink is transitioned to uplink in the subframe structure, some OFDM symbols may be set as a Guard Period (GP).

<Support of Various Numerologies>

In the next generation system, with development of wireless communication technologies, a plurality of numerologies may be provided to a UE.

The numerologies may be defined by a length of cycle prefix (CP) and a subcarrier spacing. One cell may provide a plurality of numerology to a UE. When an index of a numerology is represented by μ, a subcarrier spacing and a corresponding CP length may be expressed as shown in the following table.

TABLE 5

| μ | Δf = 2^{μ} · 15 [kHz] | CP |
|---|---|---|
| 0 | 15 | Normal |
| 1 | 30 | Normal |
| 2 | 60 | Normal, Extended |
| 3 | 120 | Normal |
| 4 | 240 | Normal |

In the case of a normal CP, when an index of a numerology is expressed by μ, the number of OLDM symbols per slot N^{slot}_{symb}, the number of slots per frame Nframe,μslot, and the number of slots per subframe Nsubframe,μslot are expressed as shown in the following table.

TABLE 6

| μ | N^{slot}_{symb} | N^{frame, μ}ₛₗₒₜ | N^{subframe, μ}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

In the case of an extended CP, when an index of a numerology is represented by μ, the number of OLDM symbols per slot N^{slot}_{symb}, the number of slots per frame Nframe,μslot, and the number of slots per subframe Nsubframe,μslot are expressed as shown in the following table.

TABLE 7

| μ | N^{slot}_{symb} | N^{frame, μ}ₛₗₒₜ | N^{subframe, μ}ₛₗₒₜ |
|---|---|---|---|
| 2 | 12 | 40 | 4 |

Meanwhile, in the next-generation mobile communication, each symbol may be used for downlink or uplink, as shown in the following table. In the following table, uplink is indicated by U, and downlink is indicated by D. In the following table, X indicates a symbol that can be flexibly used for uplink or downlink.

TABLE 8

| For- | Symbol Number in Slot | | | | | | | | | | | | | |
|---|---|---|---|---|---|---|---|---|---|---|---|---|---|---|
| mat | 0 | 1 | 2 | 3 | 4 | 5 | 6 | 7 | 8 | 9 | 10 | 11 | 12 | 13 |
| 0 | D | D | D | D | D | D | D | D | D | D | D | D | D | D |
| 1 | U | U | U | U | U | U | U | U | U | U | U | U | U | U |
| 2 | X | X | X | X | X | X | X | X | X | X | X | X | X | X |
| 3 | D | D | D | D | D | D | D | D | D | D | D | D | D | X |
| 4 | D | D | D | D | D | D | D | D | D | D | D | D | X | X |
| 5 | D | D | D | D | D | D | D | D | D | D | D | X | X | X |
| 6 | D | D | D | D | D | D | D | D | D | D | X | X | X | X |
| 7 | D | D | D | D | D | D | D | D | D | X | X | X | X | X |
| 8 | X | X | X | X | X | X | X | X | X | X | X | X | X | U |
| 9 | X | X | X | X | X | X | X | X | X | X | X | X | U | U |
| 10 | X | U | U | U | U | U | U | U | U | U | U | U | U | U |
| 11 | X | X | U | U | U | U | U | U | U | U | U | U | U | U |
| 12 | X | X | X | U | U | U | U | U | U | U | U | U | U | U |
| 13 | X | X | X | X | U | U | U | U | U | U | U | U | U | U |
| 14 | X | X | X | X | X | U | U | U | U | U | U | U | U | U |
| 15 | X | X | X | X | X | X | U | U | U | U | U | U | U | U |
| 16 | D | X | X | X | X | X | X | X | X | X | X | X | X | X |
| 17 | D | D | X | X | X | X | X | X | X | X | X | X | X | X |
| 18 | D | D | D | X | X | X | X | X | X | X | X | X | X | X |
| 19 | D | X | X | X | X | X | X | X | X | X | X | X | X | U |
| 20 | D | D | X | X | X | X | X | X | X | X | X | X | X | U |
| 21 | D | D | D | X | X | X | X | X | X | X | X | X | X | U |
| 22 | D | X | X | X | X | X | X | X | X | X | X | X | U | U |
| 23 | D | D | X | X | X | X | X | X | X | X | X | X | U | U |
| 24 | D | D | D | X | X | X | X | X | X | X | X | X | U | U |
| 25 | D | X | X | X | X | X | X | X | X | X | X | U | U | U |
| 26 | D | D | X | X | X | X | X | X | X | X | X | U | U | U |
| 27 | D | D | D | X | X | X | X | X | X | X | X | U | U | U |
| 28 | D | D | D | D | D | D | D | D | D | D | D | D | X | U |
| 29 | D | D | D | D | D | D | D | D | D | D | D | X | X | U |
| 30 | D | D | D | D | D | D | D | D | D | D | X | X | X | U |
| 31 | D | D | D | D | D | D | D | D | D | D | D | X | U | U |
| 32 | D | D | D | D | D | D | D | D | D | D | X | X | U | U |
| 33 | D | D | D | D | D | D | D | D | D | X | X | X | U | U |
| 34 | D | X | U | U | U | U | U | U | U | U | U | U | U | U |
| 35 | D | D | X | U | U | U | U | U | U | U | U | U | U | U |
| 36 | D | D | D | X | U | U | U | U | U | U | U | U | U | U |
| 37 | D | X | X | U | U | U | U | U | U | U | U | U | U | U |
| 38 | D | D | X | X | U | U | U | U | U | U | U | U | U | U |
| 39 | D | D | D | X | X | U | U | U | U | U | U | U | U | U |
| 40 | D | X | X | X | U | U | U | U | U | U | U | U | U | U |
| 41 | D | D | X | X | X | U | U | U | U | U | U | U | U | U |
| 42 | D | D | D | X | X | X | U | U | U | U | U | U | U | U |
| 43 | D | D | D | D | D | D | D | D | D | X | X | X | X | U |
| 44 | D | D | D | D | D | D | X | X | X | X | X | X | U | U |
| 45 | D | D | D | D | D | D | X | X | U | U | U | U | U | U |
| 46 | D | D | D | D | D | D | X | D | D | D | D | D | D | X |
| 47 | D | D | D | D | D | X | X | D | D | D | D | D | X | X |
| 48 | D | D | X | X | X | X | X | D | D | X | X | X | X | X |
| 49 | D | X | X | X | X | X | X | D | X | X | X | X | X | X |
| 50 | X | U | U | U | U | U | U | X | U | U | U | U | U | U |
| 51 | X | X | U | U | U | U | U | X | X | U | U | U | U | U |
| 52 | X | X | X | U | U | U | U | X | X | X | U | U | U | U |
| 53 | X | X | X | X | U | U | U | X | X | X | X | U | U | U |
| 54 | D | D | D | D | D | X | U | D | D | D | D | D | X | U |
| 55 | D | D | X | U | U | U | U | D | D | X | U | U | U | U |
| 56 | D | X | U | U | U | U | U | D | X | U | U | U | U | U |
| 57 | D | D | D | D | X | X | U | D | D | D | D | X | X | U |
| 58 | D | D | X | X | U | U | U | D | D | X | X | U | U | U |
| 59 | D | X | X | U | U | U | U | D | X | X | U | U | U | U |
| 60 | D | X | X | X | X | X | U | D | X | X | X | X | X | U |
| 61 | D | D | X | X | X | X | U | D | D | X | X | X | X | U |

<Operating Band in NR>

An operating band in NR is as follows.

An operating band shown in Table 9 is a reframing operating band that is transitioned from an operating band of LTE/LTE-A. This operating band is referred to as FR1 band.

TABLE 9

| NR | Uplink Operating | Downlink Operating | |
|---|---|---|---|
| Operating | Band | Band | Duplex |
| Band | F_{UL}_{_{—}}_{low}-F_{UL}_{_{—}}_{high} | F_{DL}_{_{—}}_{low}-F_{DL}_{_{—}}_{high} | Mode |
| n1 | 1920 MHz-1980 MHz | 2110 MHz-2170 MHz | FDD |
| n2 | 1850 MHz-1910 MHz | 1930 MHz-1990 MHz | FDD |
| n3 | 1710 MHz-1785 MHz | 1805 MHz-1880 MHz | FDD |
| n5 | 824 MHz-849 MHz | 869 MHz-894 MHz | FDD |
| n7 | 2500 MHz-2570 MHz | 2620 MHz-2690 MHz | FDD |
| n8 | 880 MHz-915 MHz | 925 MHz-960 MHz | FDD |
| n20 | 832 MHz-862 MHz | 791 MHz-821 MHz | FDD |
| n28 | 703 MHz-748 MHz | 758 MHz-803 MHz | FDD |
| n38 | 2570 MHz-2620 MHz | 2570 MHz-2620 MHz | TDD |
| n41 | 2496 MHz-2690 MHz | 2496 MHz-2690 MHz | TDD |
| n50 | 1432 MHz-1517 MHz | 1432 MHz-1517 MHz | TDD |
| n51 | 1427 MHz-1432 MHz | 1427 MHz-1432 MHz | TDD |
| n66 | 1710 MHz-1780 MHz | 2110 MHz-2200 MHz | FDD |
| n70 | 1695 MHz-1710 MHz | 1995 MHz-2020 MHz | FDD |
| n71 | 663 MHz-698 MHz | 617 MHz-652 MHz | FDD |
| n74 | 1427 MHz-1470 MHz | 1475 MHz-1518 MHz | FDD |
| n75 | N/A | 1432 MHz-1517 MHz | SDL |
| n76 | N/A | 1427 MHz-1432 MHz | SDL |
| n77 | 3300 MHz-4200 MHz | 3300 MHz-4200 MHz | TDD |
| n78 | 3300 MHz-3800 MHz | 3300 MHz-3800 MHz | TDD |
| n79 | 4400 MHz-5000 MHz | 4400 MHz-5000 MHz | TDD |
| n80 | 1710 MHz-1785 MHz | N/A | SUL |
| n81 | 880 MHz-915 MHz | N/A | SUL |
| n82 | 832 MHz-862 MHz | N/A | SUL |
| n83 | 703 MHz-748 MHz | N/A | SUL |
| n84 | 1920 MHz-1980 MHz | N/A | SUL |

The following table shows an NR operating band defined at high frequencies. This operating band is referred to as FR2 band.

TABLE 10

| NR | Uplink Operating | Downlink Operating | |
|---|---|---|---|
| Operating | Band | Band | Duplex |
| Band | F_{UL}_{_{—}}_{low}-F_{UL}_{_{—}}_{high} | F_{DL}_{_{—}}_{low}-F_{DL}_{_{—}}_{high} | Mode |
| n257 | 26500 MHz-29500 MHz | 26500 MHz-29500 MHz | TDD |
| n258 | 24250 MHz-27500 MHz | 24250 MHz-27500 MHz | TDD |
| n259 | 37000 MHz-40000 MHz | 37000 MHz-40000 MHz | TDD |
| n260 | 27500 MHz-28350 MHz | 27500 MHz-28350 MHz | TDD |

Meanwhile, when the operating band shown in the above table is used, a channel bandwidth is used as shown in the following table.

TABLE 11

| | 5 | 10 | 15 | 20 | 25 | 30 | 40 | 50 | 60 | 80 | 100 |
|---|---|---|---|---|---|---|---|---|---|---|---|
| SCS | MHz | MHz | MHz | MHz | MHz | MHz | MHz | MHz | MHz | MHz | MHz |
| (kHz) | N_{RB} | N_{RB} | N_{RB} | N_{RB} | N_{RB} | N_{RB} | N_{RB} | N_{RB} | N_{RB} | N_{RB} | N_{RB} |
| 15 | 25 | 52 | 79 | 106 | 133 | [160] | 216 | 270 | N/A | N/A | N/A |
| 30 | 11 | 24 | 38 | 51 | 65 | [78] | 106 | 133 | 162 | 217 | 273 |
| 60 | N/A | 11 | 18 | 24 | 31 | [38] | 51 | 65 | 79 | 107 | 135 |

In the above table, SCS indicates a subcarrier spacing. In the above table, NRB indicates the number of RBs.

Meanwhile, when the operating band shown in the above table is used, a channel bandwidth is used as shown in the following table.

TABLE 12

| SCS | 50 MHz | 100 MHz | 200 MHz | 400 MHz |
|---|---|---|---|---|
| (kHz) | N_{RB} | N_{RB} | N_{RB} | N_{RB} |
| 60 | 66 | 132 | 264 | N.A |
| 120 | 32 | 66 | 132 | 264 |

<SS Block in NR>

In the 5G NR, information required for a UE to perform an initial access, that is, a Physical Broadcast Channel (PBCH) including a Master Information Block (MIB) and a synchronization signal (SS) (including PSS and SSS) are defined as an SS block. In addition, a plurality of SS blocks may be grouped and defined as an SS burst, and a plurality of SS bursts may be grouped and defined as an SS burst set. It is assumed that each SS block is beamformed in a particular direction, and various SS blocks existing in an SS burst set are designed to support UEs existing in different directions.

FIG. 6 is a Diagram Illustrating an Example of an SS Block in NR.

Referring to FIG. 6, an SS burst is transmitted in every predetermined periodicity. Accordingly, a UE receives SS blocks, and performs cell detection and measurement.

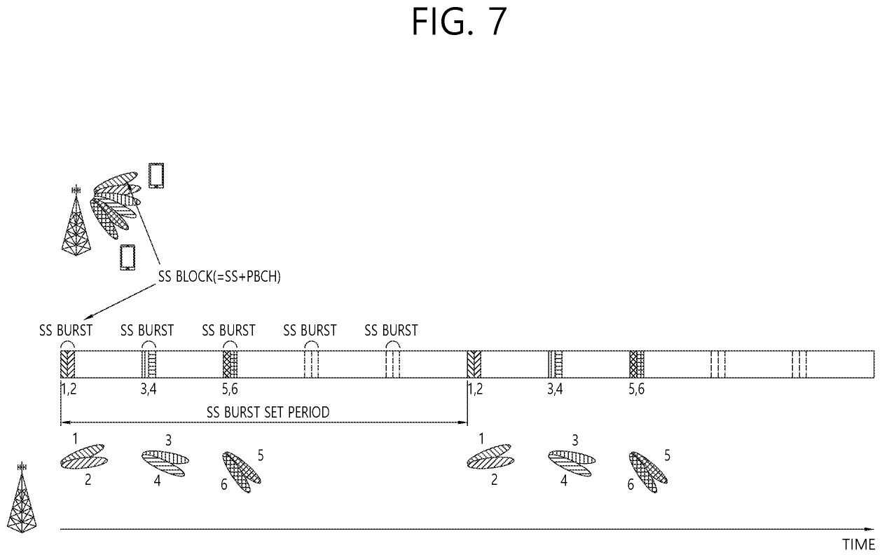

Meanwhile, in the 5G NR, beam sweeping is performed on an SS. A detailed description thereof will be provided with reference to FIG. 7.

FIG. 7 is a Diagram Illustrating an Example of Beam Sweeping in the NR.

A base station transmits each SS block in an SS burst over time while performing beam sweeping. In this case, multiple SS blocks in an SS burst set are transmitted to support UEs existing in different directions. In FIG. 6, the SS burst set includes one to six SS blocks, and each SS burst includes two SS blocks.

<Channel Raster and Sync Raster>

Hereinafter, a channel raster and a sync rater will be described.

A frequency channel raster is defined as a set of RF reference frequencies (FREF). An RF reference frequency may be used as a signal indicative of locations of an RF channel, an SS block, and the like.

A global frequency raster may be defined with respect to all frequencies from 0 GHz to 100 GHz. The granularity of the global frequency raster may be expressed by ΔFGlobal.

An RF reference frequency is designated by NR Absolute Radio Frequency Channel Number (NR-AFRCN) in the global frequency raster's range (0 . . . 2016666). A relationship between the NR-AFRCN and the RF reference frequency (FREF) of MHz may be expressed as shown in the following equation. Here, FREF-Offs and NRef-Offs are expressed as shown in the following Table.

FREF=FREF-Offs+ΔFGlobal(NREF−NREF-Offs) [Equation 1]

TABLE 13

| Frequency Range | ΔF_{Global} | F_{REF-Offs} | | |
|---|---|---|---|---|
| (MHz) | (kHz) | (MHz) | N_{REF-Offs} | Range of N_{REF} |
| 0-3000 | 5 | 0 | 0 | 0-599999 |
| 3000-24250 | 15 | 3000 | 600000 | 600000-2016666 |
| 24250-100000 | 60 | 24250.08 | 2016667 | 2016667-3279165 |

A channel raster indicates a subset of FR reference frequencies able to be used to identify location of an RF channel in uplink and downlink. An RF reference frequency for an RF channel may be mapped to a resource element on a subcarrier.

Mapping of the RF reference frequency of the channel raster and the corresponding resource element may be used to identify a location of an RF channel. The mapping may differ according to a total number of RBs allocated to the channel, and the mapping applies to both uplink (UL) and downlink (DL).

When NRB mod 2=0,

the RE index k is 0, and

the number of PRBs is as below.

$${n}_{P R B} = ⌊ \frac{{N}_{R B}}{2} ⌋$$

Locations of RF channels of a channel raster in each NR operating band may be expressed as shown in the following table.

TABLE 14

| NR | | Uplink Frequency | Uplink Frequency |
|---|---|---|---|
| Operating | ΔF_{Raster} | Range of N_{REF} | Range of N_{REF} |
| Band | (kHz) | (First-<Step size>-Last) | (First-<Step size>-Last) |
| n1 | 100 | 384000-<20>-396000 | 422000-<20>-434000 |
| n2 | 100 | 370000-<20>-382000 | 386000-<20>-398000 |
| n3 | 100 | 342000-<20>-357000 | 361000-<20>-376000 |
| n5 | 100 | 164800-<20>-169800 | 173800-<20>-178800 |
| n7 | 100 | 500000-<20>-514000 | 524000-<20>-538000 |
| n8 | 100 | 176000-<20>-183000 | 185000-<20>-192000 |
| n12 | 100 | 139800-<20>-143200 | 145800-<20>-149200 |
| n20 | 100 | 166400-<20>-172400 | 158200-<20>-164200 |
| n25 | 100 | 370000-<20>-383000 | 386000-<20>-399000 |
| n28 | 100 | 140600-<20>-149600 | 151600-<20>-160600 |
| n34 | 100 | 402000-<20>-405000 | 402000-<20>-405000 |
| n38 | 100 | 514000-<20>-524000 | 514000-<20>-524000 |
| n39 | 100 | 376000-<20>-384000 | 376000-<20>-384000 |
| n40 | 100 | 460000-<20>-480000 | 460000-<20>-480000 |
| n41 | 15 | 499200-<3>-537999 | 499200-<3>-537999 |
| | 30 | 499200-<6>-537996 | 499200-<6>-537996 |
| n51 | 100 | 285400-<20>-286400 | 285400-<20>-286400 |
| n66 | 100 | 342000-<20>-356000 | 422000-<20>-440000 |
| n70 | 100 | 339000-<20>-342000 | 399000-<20>-404000 |
| n71 | 100 | 132600-<20>-139600 | 123400-<20>-130400 |
| n75 | 100 | N/A | 286400-<20>-303400 |
| n76 | 100 | N/A | 285400-<20>-286400 |
| n77 | 15 | 620000-<1>-680000 | 620000-<1>-680000 |
| | 30 | 620000-<2>-680000 | 620000-<2>-680000 |
| n78 | 15 | 620000-<1>-653333 | 620000-<1>-653333 |
| | 30 | 620000-<2>-653332 | 620000-<2>-653332 |
| n79 | 15 | 693334-<1>-733333 | 693334-<1>-733333 |
| | 30 | 693334-<2>-733332 | 693334-<2>-733332 |
| n80 | 100 | 342000-<20>-357000 | N/A |
| n81 | 100 | 176000-<20>-183000 | N/A |
| n82 | 100 | 166400-<20>-172400 | N/A |
| n83 | 100 | 140600-<20>-149600 | N/A |
| n84 | 100 | 384000-<20>-396000 | N/A |
| n86 | 100 | 342000-<20>-356000 | N/A |

TABLE 15

| NR Operating | ΔF_{Raster} | Uplink and Downlink Frequency Range |
|---|---|---|
| Band | (kHz) | (First-<Step size>-Last) |
| n257 | 60 | 2054166-<1>-2104165 |
| | 120 | 2054167-<2>-2104165 |
| n258 | 60 | 2016667-<1>-2070832 |
| | 120 | 2016667-<2>-2070831 |
| n260 | 60 | 2229166-<1>-2279165 |
| | 120 | 2229167-<2>-2279165 |
| n261 | 60 | 2070833-<1>-2084999 |
| | 120 | 2070833-<2>-2087497 |

Meanwhile, a sync raster indicates a frequency location of an SS block used by a UE to acquire system information. The frequency location of the SS block may be defined as SSREF using a GSCN number corresponding thereto

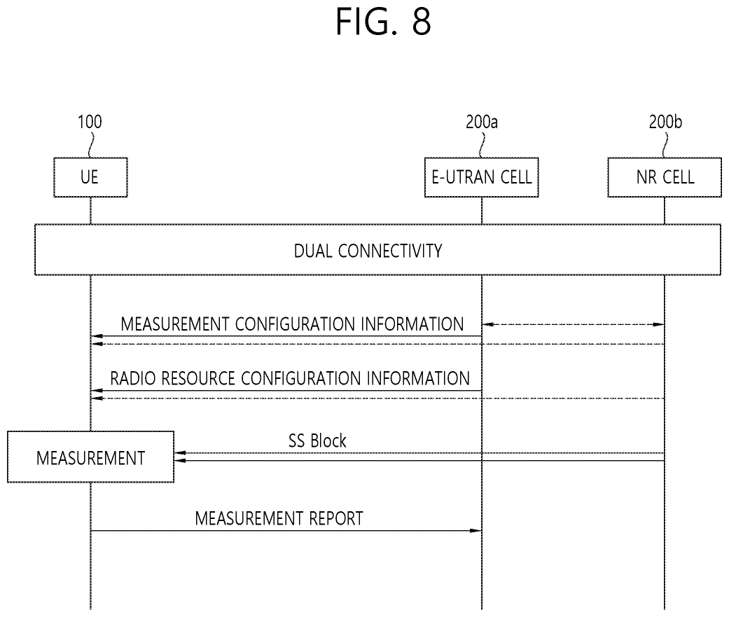

FIG. 8 Shows an Example of Performing Measurement in E-UTRAN and NR (EN) DC Case.

Referring to FIG. 8, the UE 100 are connected in EN-DC with an E-UTRAN (that is, LTE/LTE-A) cell. Here, a Pcell in EN-DC may be an E-UTRAN (that is, LTE/LTE-A) cell, and a PSCell in EN-DC may be an NR cell.

The UE 100 may receive measurement configuration (or “measconfig”) information element (IE) of the E-UTRAN (that is, LTE/LTE-A) cell. The measurement configuration (or “measconfig”) IE received from the E-UTRAN (that is, LTE/LTE-A) cell may further include fields shown in the following table, in addition to the fields shown in Table 2.

TABLE 16

MeasConfig field description
fr1-Gap
This field exists when a UE is configured with EN-DC. This field
indicates whether a gap is applied to perform measurement on
FR1 band (that is, a band shown in Table 9).
MeasConfig field description
mgta
It indicates whether to apply a timing advance (TA) of 0.5 ms
for a measurement gap configuration provided by the E-UTRAN.

The measurement configuration (or “measconfig”) IE may further include a measGapConfig field for setting a measurement gap (MG), as shown in Table 2. A gapoffset field within the measGapConfig field may further include gp4, gp5, . . . , gp11 for EN-DC, in addition to the example shown in Table 3.

Meanwhile, the UE 100 may receive a measurement configuration (“measconfig”) IE of an NR cell, which is a PSCell, directly from the NR cell or through the E-UTRAN cell which is a Pcell.

Meanwhile, the measurement configuration (“measconfig”) IE of the NR cell may include fields as shown in the following table.

TABLE 17
MeasConfig field description
measGapConfig
It indicates configuration or cancelation of a measurement gap
s-MeasureConfig
It indicates a threshold value for measurement of NR SpCell RSRP when a
UE needs to perform measurement on a non-serving cell.

The above measGapConfig may further include fields as shown in the following table.

TABLE 18
MeasGapConfig field description
gapFR2
It indicates a measurement gap configuration applicable for FR2 frequency
range.
gapOffset
It indicates a gap offset of a gap pattern with an MGRP.
mgl
It indicates a measurement gap length by ms. There may be 3 ms, 4 ms,
6 ms, etc.
mgrp
It indicates a measurement gap repetition period by ms.
mgta
It indicates whether to apply a timing advance (TA) of 0.5 ms for a
measurement gap configuration.

Meanwhile, as shown in the drawing, the UE 100 receives a radio resource configuration information element (IE) of the E-UTRAN (that is, LTE/LTE-A) cell which is a Pcell. In addition, the UE may receive a radio resource configuration IE of an NR cell, which is a PSCell, from the NR cell or through the E-UTRAN cell which is a Pcell. The radio resource configuration IE includes subframe pattern information, as described above with reference to FIG. 3. The UE 100 performs measurement and reports a measurement result. Specifically, the UE 100 interrupts data transmission and reception with the E-UTRAN (that is, LTE/LTE-A) cell during the measurement gap, retunes its own RF chain, and performs measurement based on receipt of an SS block from an NR cell.

<Disclosure of the Present Specification>

I. First Disclosure

The first disclosure provides a behavior and/or requirement of a wireless device related to a maximum receive timing difference (MRTD) and a maximum transmission timing difference (MTTD) in an inter-band synchronous case and EN DC case.

For inter-band synchronous EN-DC, the MRTD and the MTTD have not been researched for higher SCS such as 30 kHz, 60 kHz and 120 kHz. For the MRTD and MTTD, a network deployment scenarios, a power control related UE implementation and a timing alignment error (TAE) between inter-band NR CA should be considered.

A. Network Deployment Scenarios.

LTE network deployment is not changed due to EN-DC and is kept. If NR network is deployed for EN-DC, a propagation delay difference between a E-UTRA based eNB to UE and a NR based gNB to UE is not dependent of NS SCS. For example of agreed MRTD of 33 us for NR SCS of 15 kHz, 30 us is propagation delay difference and 3 us is TAE (timing alignment error) between eNB (E-UTRA) and gNB (NR). The propagation delay difference of 30 us is not changed due to NR SCS of 30 kHz, 60 kHz and 120 kHz. However, it does not mean that the propagation delay difference can be used to define MRTD for higher NR SCS.

B. Power Control Related UE Implementation

One half NR OFDM symbol needs to be considered for the MRTD and MTTD in aspect of UE implementation related to power control and AGC. Below table shows the one half NR OFDM symbol duration.

TABLE 19

| NR SCS (kHz) | 15 | 30 | 60 | 120 |
|---|---|---|---|---|
| OFDM symbol | 66.67 | 33.33 | 16.67 | 8.33 |
| duration(us) | | | | |
| CP duration(us) | 4.69 | 2.34 | 1.17 | 0.57 |
| OFDM symbol | 71.35 | 35.68 | 17.84 | 8.92 |
| including CP(us) | | | | |
| OFDM one half symbol | 33.33 | 16.67 | 8.33 | 4.17 |
| duration(us) | | | | |

C. TAE Between Inter-Band NR CA the TAE does not Exceed [3 μs] for Inter-Band NR CA. The TAE can be Considered for the MRTD and MTTD.

Regarding three aspects above, one half symbol corresponding NR SCS can be interpreted if it divides propagation delay difference and TAE according to whether to consider UE complexity of implementation or not as follows. Below table shows a MRTD for inter-band synchronous EN-DC.

TABLE 20

| | considering UE complexity | | | | not considering UE complexity | | | |
|---|---|---|---|---|---|---|---|---|
| NR SCS (kHz) | 15 | 30 | 60 | 120 | 15 | 30 | 60 | 120 |
| MRTD (us) | 33 | 17 | 8 | 4 | 33 | 33 | 33 | 33 |
| Propagation | 30 | 14 | 5 | 1 | 30 | 30 | 30 | 30 |
| delay | (9 km) | (4.2 km) | (1.5 km) | (0.3 km) | (9 km) | (9 km) | (9 km) | (9 km) |
| difference(us)/ | | | | | | | | |
| (distance | | | | | | | | |
| difference(km)) | | | | | | | | |
| TAE(us) | 3 | 3 | 3 | 3 | 3 | 3 | 3 | 3 |

The main different thing for MRTD by UE complexity is to limit inter-band synchronous EN-DC operation depending on UE location and deployed NR gNB location within E-UTRA eNB coverage at higher NR SCS.

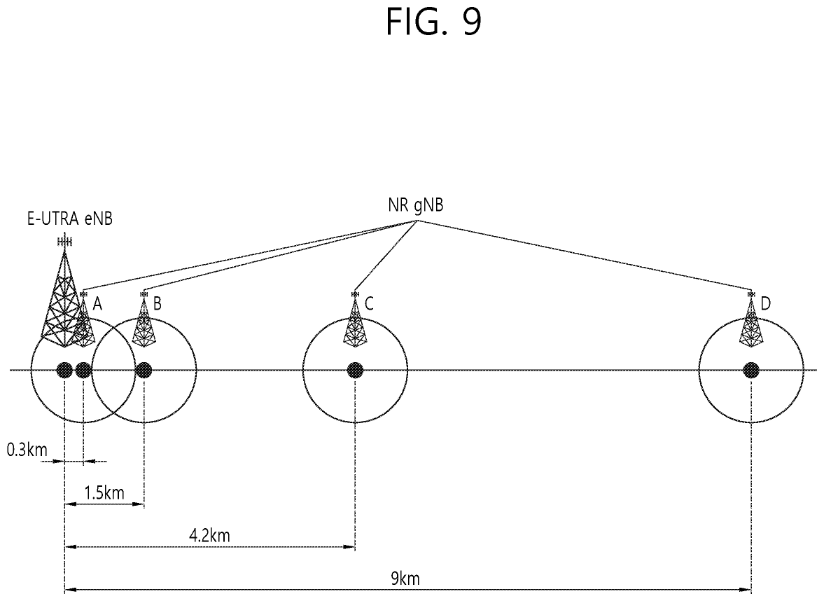

FIG. 9 Shows an Example of Deployment of EN-DC.

4 different NR gNBs are assumed to be deployed with distance of 0.3 km, 1.5 km, 4.2 km and 9 km from E-UTRA eNB. Depending on with or without considering UE complexity of implementation, inter-band synchronous EN-DC or inter-band asynchronous EN-DC can be divided according to NR SCS for the UE which is served from NR gNB, such as A, B, C and D as below table. The below table shows possible inter-band synchronous EN-DC according to NR SCS in UE side.

TABLE 21

| | | | | |
|---|---|---|---|---|
| NR SCS | A | B | C | D |
| (kHz) | (~0.3 km) | (0.3~1.5 km) | (1.5~4.2 km) | (4.2~9 km) |

considering UE complexity

| | | | | |
|---|---|---|---|---|
| 15 | Sync. | Sync. | Sync. | Sync. |
| 30 | Sync. | Sync. | Sync. | Async. |
| 60 | Sync. | Sync. | Async. | Async. |
| 120 | Sync. | Async. | Async. | Async. |

not considering UE complexity

| | | | | |
|---|---|---|---|---|
| 15 | Sync. | Sync. | Sync. | Sync. |
| 30 | | | | |
| 60 | | | | |
| 120 | | | | |

As shown in the above table, inter-band synchronous EN-DC operation in UE side is very limited when considering UE complexity. On the other hand, in case of not considering UE complexity inter-band synchronous EN-DC operation in UE side is not limited and is regardless of NR SCS. It can give significant impact in aspect of NW operation and UE applicability related to synchronous EN-DC. Therefore, it is desirable to specify the separate MRTD and MTTD requirement for the limited inter-band synchronous EN-DC and the non-limited inter-band synchronous EN-DC from UE side. And, UE capability is needed to differentiate the limited inter-band synchronous EN-DC and the non-limited inter-band synchronous EN-DC in UE side.

Proposal 1: For inter-band synchronous EN-DC, define a separate MRTD and MTTD for inter-band synchronous EN-DC based on UE capability of complexity of implementation.

Proposal 1a: UE capability is needed to differentiate a limited inter-band synchronous EN-DC and a non-limited inter-band synchronous EN-DC from UE side based on UE complexity of implementation.

Proposal 2: For inter-band synchronous EN-DC with considering UE complexity of implementation, MRTD is proposed with 17 us, 8 us and 4 us for DL NR SCS of 30 kHz, 60 kHz and 120 kHz respectively in addition to 33 us corresponding to DL NR SCS of 15 kHz.

Proposal 3: For inter-band synchronous EN-DC without considering UE complexity of implementation, MRTD is proposed with 33 us for all DL NR SCSs. Here, all DL SCSs include 15 kHz, 30 kHz, 60 kHz and 120 kHz. That is, MRTD is proposed with 33 us regardless of whether DL SCS is 15 kHz, 30 kHz, 60 kHz or 120 kHz. Here, as above explained, EN-DC means that a first cell and a second cell are configured for dual connectivity. And, the first cell is an E-UTRA based cell and the second cell is a NR based cell. The first cell is a primary cell and the second cell is a secondary cell.

For MTTD, it is interpreted with MRTD+(transmission timing error+uncertainty of receiving time). Therefore, transmission timing error and uncertainty of receiving time for both E-UTRA and NR need to be identified. For E-UTRA, transmission timing error of 24Ts and uncertainty of 10Ts can be reused.

For NR, NR transmission timing error was already agreed as the below table. Here, 1Ts=64Tc. Below table shows Te (Timing Error) Limit

TABLE 22

| Frequency | SCS of SSB | SCS of uplink | |
|---|---|---|---|
| Range | signals (KHz) | signals s(KHz) | Te |
| FR1 | 15 | 15 | [12]*64*Tc |
| | | 30 | [10]*64*Tc |
| | | 60 | [10]*64*Tc |
| | 30 | 15 | [8]*64*Tc |
| | | 30 | [8]*64*Tc |
| | | 60 | [7]*64*Tc |
| FR2 | 120 | 60 | [3.5]*64*Tc |
| | | 120 | [3.5]*64*Tc |
| | 240 | 60 | [3]*64*Tc |
| | | 120 | [3]*64*Tc |

Tc is the basic timing unit (eg. Tc=1/(480000*4096) second). For NR, based on 10Ts in E-UTRA, we scales the value with 1, ½, ¼ and ⅛ for NR SCS as the below table. The below table shows Tᵤ (Uncertainty of receiving time in PSCell)

TABLE 23

| DL Sub-carrier spacing in | Tu: uncertainty of |
|---|---|
| PSCell (kHz) | receiving time (Ts) |
| 15 | 10 |
| 30 | 5 |
| 60 | 2.5 |
| 120 | 1.25 |

The above table shows the total transmission timing error and uncertainty of receiving time for FR1 and FR2. The calculated total transmission timing error and uncertainty are from 1.50 us to 1.82 us in FR1 and from 1.25 us to 1.30 us in FR2. It seems small difference for FR1 and FR2. Regarding small difference among the calculated values, one value for FR1 and one value for FR2 seem to be desirable for simplicity.

The below table shows a total transmission timing error and uncertainty of receiving time.

TABLE 24

| | | | | Total transmission | | | | |
|---|---|---|---|---|---|---|---|---|
| | SCS | SCS | SCS | timing error and | | | | |
| Freq. | of SSB | of DL | of UL | uncertainty of | Te in | Te in | Tu in | Tu in |
| Range | (KHz) | (KHz) | (KHz) | receiving time (us) | PCell | PSCell | PCell | PSCell |
| FR1 | 15 | 15 | 15 | 1.82 | 24*Tₛ | [12]*Tₛ | 10*Tₛ | [10]*Tₛ |
| | | 15 | 30 | 1.76 | 24*Tₛ | [10]*Tₛ | 10*Tₛ | [10]*Tₛ |
| | | 15 | 60 | 1.76 | 24*Tₛ | [10]*Tₛ | 10*Tₛ | [10]*Tₛ |
| | | 30 | 15 | 1.82 | 24*Tₛ | [12]*Tₛ | 10*Tₛ | [10]*Tₛ |
| | | 30 | 30 | 1.76 | 24*Tₛ | [10]*Tₛ | 10*Tₛ | [10]*Tₛ |
| | | 30 | 60 | 1.76 | 24*Tₛ | [10]*Tₛ | 10*Ts | [10]*Tₛ |
| | | 60 | 15 | 1.82 | 24*Tₛ | [12]*Tₛ | 10*Ts | [10]*Tₛ |
| | | 60 | 30 | 1.76 | 24*Tₛ | [10]*Tₛ | 10*Ts | [10]*Tₛ |
| | | 60 | 60 | 1.76 | 24*Tₛ | [10]*Tₛ | 10*Ts | [10]*Tₛ |
| | 30 | 15 | 15 | 1.69 | 24*Tₛ | [8]*Tₛ | 10*Ts | [10]*Tₛ |
| | | 15 | 30 | 1.69 | 24*Tₛ | [8]*Tₛ | 10*Ts | [10]*Tₛ |
| | | 15 | 60 | 1.66 | 24*Tₛ | [7]*Tₛ | 10*Ts | [10]*Tₛ |
| | | 30 | 15 | 1.53 | 24*Tₛ | [8]*Tₛ | 10*Ts | [5]*Tₛ |
| | | 30 | 30 | 1.53 | 24*Tₛ | [8]*Tₛ | 10*Ts | [5]*Tₛ |
| | | 30 | 60 | 1.50 | 24*Tₛ | [7]*Tₛ | 10*Ts | [5]*Tₛ |
| | | 60 | 15 | 1.53 | 24*Tₛ | [8]*Tₛ | 10*Ts | [5]*Tₛ |
| | | 60 | 30 | 1.53 | 24*Tₛ | [8]*Tₛ | 10*Ts | [5]*Tₛ |
| | | 60 | 60 | 1.50 | 24*Tₛ | [7]*Tₛ | 10*Ts | [5]*Tₛ |
| FR2 | 120 | 60 | 60 | 1.30 | 24*Tₛ | [3.5]*Tₛ | 10*Ts | [2.5]*Tₛ |
| | | 60 | 120 | 1.30 | 24*Tₛ | [3.5]*Tₛ | 10*Ts | [2.5]*Tₛ |
| | | 120 | 60 | 1.26 | 24*Tₛ | [3.5]*Tₛ | 10*Ts | [1.25]*Tₛ |
| | | 120 | 120 | 1.26 | 24*Tₛ | [3.5]*Tₛ | 10*Ts | [1.25]*Tₛ |
| | 240 | 60 | 60 | 1.29 | 24*Tₛ | [3]*Tₛ | 10*Ts | [2.5]*Tₛ |
| | | 60 | 120 | 1.29 | 24*Tₛ | [3]*Tₛ | 10*Ts | [2.5]*Tₛ |
| | | 120 | 60 | 1.25 | 24*Tₛ | [3]*Tₛ | 10*Tₛ | [1.25]*Tₛ |
| | | 120 | 120 | 1.25 | 24*Tₛ | [3]*Tₛ | 10*Tₛ | [1.25]*Tₛ |

MTTD of 35.21 us(=33 us(MRTD)+2.21 us) was agreed for NR SCS of 15 kHz. Here, 2.21 us was assumed for the total transmission timing error and uncertainty of receiving time. Comparing with the calculated 1.82 us in the below table, about 0.4 us is considered as margin. With the margin of 0.4 us, our preferable value is 2.21 us for FR1 and 1.7 us for FR2 for the total transmission timing error and uncertainty of receiving time. Another preference is 2.21 us for both FR1(Sub6 GHz) and FR2(mmWave). The below table shows the calculated MTTD for inter-band synchronous EN-DC with 2.21 us for FR1 and 1.7 us for FR2.

TABLE 25

| | | | | Total transmission | MRTD with | MRTD without | MTTD with | MTTD without |
|---|---|---|---|---|---|---|---|---|
| | SCS | SCS | SCS | timing error and | considering UE | considering UE | considering UE | considering UE |
| | of | of | of | uncertainty of | complexity of | complexity of | complexity of | complexity of |
| Freq. | SSB | DL | UL | receiving time | implementation | implementation | implementation | implementation |
| Range | (KHz) | (KHz) | (KHz) | (us) | (us) | (us) | (us) | (us) |
| FR1 | 15 | 15 | 15 | 2.21 | 33 | 33 | 35.21 | 35.21 |
| | | 15 | 30 | 2.21 | 33 | 33 | 35.21 | 35.21 |
| | | 15 | 60 | 2.21 | 33 | 33 | 35.21 | 35.21 |
| | | 30 | 15 | 2.21 | 33 | 33 | 35.21 | 35.21 |
| | | 30 | 30 | 2.21 | 33 | 33 | 35.21 | 35.21 |
| | | 30 | 60 | 2.21 | 33 | 33 | 35.21 | 35.21 |
| | | 60 | 15 | 2.21 | 33 | 33 | 35.21 | 35.21 |
| | | 60 | 30 | 2.21 | 33 | 33 | 35.21 | 35.21 |
| | | 60 | 60 | 2.21 | 33 | 33 | 35.21 | 35.21 |
| | 30 | 15 | 15 | 2.21 | 33 | 33 | 35.21 | 35.21 |
| | | 15 | 30 | 2.21 | 33 | 33 | 35.21 | 35.21 |
| | | 15 | 60 | 2.21 | 33 | 33 | 35.21 | 35.21 |
| | | 30 | 15 | 2.21 | 17 | 33 | 19.21 | 35.21 |
| | | 30 | 30 | 2.21 | 17 | 33 | 19.21 | 35.21 |
| | | 30 | 60 | 2.21 | 17 | 33 | 19.21 | 35.21 |
| | | 60 | 15 | 2.21 | 17 | 33 | 19.21 | 35.21 |
| | | 60 | 30 | 2.21 | 17 | 33 | 19.21 | 35.21 |
| | | 60 | 60 | 2.21 | 17 | 33 | 19.21 | 35.21 |
| FR2 | 120 | 60 | 60 | 1.70 | 8 | 33 | 9.7 | 34.7 |
| | | 60 | 120 | 1.70 | 8 | 33 | 9.7 | 34.7 |
| | | 120 | 60 | 1.70 | 4 | 33 | 5.7 | 34.7 |
| | | 120 | 120 | 1.70 | 4 | 33 | 5.7 | 34.7 |
| | 240 | 60 | 60 | 1.70 | 8 | 33 | 9.7 | 34.7 |
| | | 60 | 120 | 1.70 | 8 | 33 | 9.7 | 34.7 |
| | | 120 | 60 | 1.70 | 4 | 33 | 5.7 | 34.7 |
| | | 120 | 120 | 1.70 | 4 | 33 | 5.7 | 34.7 |

From the the above table, the present specification proposes MTTD for inter-band synchronous EN-DC.

Proposal 4: For inter-band synchronous EN-DC with considering UE complexity of implementation, MTTD is proposed with 19.21 us, 9.7 us and 5.7 us for DL NR SCS of 30 kHz, 60 kHz and 120 kHz respectively in addition to 35.21 us corresponding to DL NR SCS of 15 kHz.

Proposal 5: For inter-band synchronous EN-DC without considering UE complexity of implementation, MTTD is proposed with 35.21 us for DL NR SCS of 15 kHz and 30 kHz, and 34.7 us for DL NR SCS of 60 kHz and 120 kHz.

The below table shows the calculated MTTD for inter-band synchronous EN-DC with 2.21 us for both FR1 and FR2.

TABLE 26

| | | | | Total transmission | MRTD with | MRTD without | MTTD with | MTTD without |
|---|---|---|---|---|---|---|---|---|
| | SCS | SCS | SCS | timing error and | considering UE | considering UE | considering UE | considering UE |
| | of | of | of | uncertainty of | complexity of | complexity of | complexity of | complexity of |
| Freq. | SSB | DL | UL | receiving time | implementation | implementation | implementation | implementation |
| Range | (KHz) | (KHz) | (KHz) | (us) | (us) | (us) | (us) | (us) |
| 1 | 15 | 15 | 15 | 2.21 | 33 | 33 | 35.21 | 35.21 |
| | | 15 | 30 | 2.21 | 33 | 33 | 35.21 | 35.21 |
| | | 15 | 60 | 2.21 | 33 | 33 | 35.21 | 35.21 |
| | | 30 | 15 | 2.21 | 33 | 33 | 35.21 | 35.21 |
| | | 30 | 30 | 2.21 | 33 | 33 | 35.21 | 35.21 |
| | | 30 | 60 | 2.21 | 33 | 33 | 35.21 | 35.21 |
| | | 60 | 15 | 2.21 | 33 | 33 | 35.21 | 35.21 |
| | | 60 | 30 | 2.21 | 33 | 33 | 35.21 | 35.21 |
| | | 60 | 60 | 2.21 | 33 | 33 | 35.21 | 35.21 |
| | 30 | 15 | 15 | 2.21 | 33 | 33 | 35.21 | 35.21 |
| | | 15 | 30 | 2.21 | 33 | 33 | 35.21 | 35.21 |
| | | 15 | 60 | 2.21 | 33 | 33 | 35.21 | 35.21 |
| | | 30 | 15 | 2.21 | 17 | 33 | 19.21 | 35.21 |
| | | 30 | 30 | 2.21 | 17 | 33 | 19.21 | 35.21 |
| | | 30 | 60 | 2.21 | 17 | 33 | 19.21 | 35.21 |
| | | 60 | 15 | 2.21 | 17 | 33 | 19.21 | 35.21 |
| | | 60 | 30 | 2.21 | 17 | 33 | 19.21 | 35.21 |
| | | 60 | 60 | 2.21 | 17 | 33 | 19.21 | 35.21 |
| 2 | 120 | 60 | 60 | 2.21 | 8 | 33 | 10.21 | 35.21 |
| | | 60 | 120 | 2.21 | 8 | 33 | 10.21 | 35.21 |
| | | 120 | 60 | 2.21 | 4 | 33 | 6.21 | 35.21 |
| | | 120 | 120 | 2.21 | 4 | 33 | 6.21 | 35.21 |
| | 240 | 60 | 60 | 2.21 | 8 | 33 | 10.21 | 35.21 |
| | | 60 | 120 | 2.21 | 8 | 33 | 10.21 | 35.21 |
| | | 120 | 60 | 2.21 | 4 | 33 | 6.21 | 35.21 |
| | | 120 | 120 | 2.21 | 4 | 33 | 6.21 | 35.21 |

From the above table, the present specification proposes MTTD for inter-band synchronous EN-DC. Proposal 4a: For inter-band synchronous EN-DC with considering UE complexity of implementation, MTTD is proposed with 19.21 us, 10.21 us and 6.21 us for DL NR SCS of 30 kHz, 60 kHz and 120 kHz respectively in addition to 35.21 us corresponding to DL NR SCS of 15 kHz.

Proposal 5a: For inter-band synchronous EN-DC without considering UE complexity of implementation, MTTD is proposed with 35.21 us for all NR SCS. That is, MTTD is proposed with 35.21 us regardless of whether SCS is 15 kHz, 30 kHz, 60 kHz or 120 kHz. Here, as above explained, EN-DC means that a first cell and a second cell are configured for dual connectivity. And, the first cell is an E-UTRA based cell and the second cell is a NR based cell. The first cell is a primary cell and the second cell is a secondary cell.

Above proposals, DL NR SCS is minimum SCS between NR SSB SCS and NR DL DATA SCS. The below table shows our proposed MRTD and MTTD for inter-band synchronous EN-DC.

The below table shows the proposed MRTD and MTTD for inter-band synchronous EN-DC

TABLE 27

| | considering UE complexity | | | | Not considering UE complexity | | | |
|---|---|---|---|---|---|---|---|---|
| DL NR SCS(kHz) | 15 | 30 | 60 | 120 | 15 | 30 | 60 | 120 |
| MRTD (us) | 33 | 17 | 8 | 4 | 33 | 33 | 33 | 33 |
| MTTD (us): | 35.21 | 19.21 | 9.7 | 5.7 | 35.21 | 35.21 | 34.7 | 34.7 |
| option1 | | | | | | | | |
| MTTD (us): | 35.21 | 19.21 | 10.21 | 6.21 | 35.21 | 35.21 | 35.21 | 35.21 |
| option2 | | | | | | | | |

Here, DL NR Sub-carrier spacing is min{SCS_{SS}, SCS_{DATA}}. Proposal 5: For inter-band synchronous EN-DC without considering UE complexity of implementation, MTTD is proposed with 35.21 us for DL NR SCS of 15 kHz and 30 kHz, and 34.7 us for DL NR SCS of 60 kHz and 120 kHz.

I-1. Modification to 3GPP Standard Based on the First Disclosure

I-1-1. Maximum Transmission Timing Difference

A UE shall be capable of handling a relative transmission timing difference between subframe timing boundary of E-UTRA PCell and slot timing boundaries of PSCell to be aggregated E-UTRA-NR dual connectivity.

Minimum Requirements for E-UTRA-NR Dual Connectivity is as follows:

For inter-band E-UTRA-NR dual connectivity, the UE shall be capable of handling a maximum uplink transmission timing difference between E-UTRA PCell and PSCell as shown in the below table. The below table shows a maximum uplink transmission timing difference requirement for asynchronous operation.

TABLE 28

| Sub-carrier | UL Sub-carrier | Maximum uplink |
|---|---|---|
| spacing in E-UTRA | spacing for data | transmission timing |
| PCell (kHz) | in PSCell (kHz) | difference (μs) |
| 15 | 15 | 500 |
| 15 | 30 | 250 |
| 15 | 60 | 125 |
| 15 | 120Note1 | 62.5 |

Note1
For intra-band FDD-FDD E-UTRA-NR dual connectivity, 120 kHz is not applied.

For inter-band TDD-TDD (E-UTRA PCell-PSCell) and inter-band TDD-FDD (E-UTRA PCell-PSCell or PSCell-E-UTRA PCell) combinations, the UE shall meet the requirements in the above table provided that the UE indicates that it is capable of asynchronous dual connectivity. For inter-band TDD-TDD (E-UTRA PCell-PSCell) and inter-band TDD-FDD (E-UTRA PCell-PSCell or PSCell-E-UTRA PCell) combinations, the UE shall meet the requirements in the below table provided that the UE indicates that it is capable of synchronous dual connectivity only. The UE is assumed that there is no limitation of implementation related to power control and ACG within 33 us.

The below table shows a maximum uplink transmission timing difference requirement for synchronous operation in inter-band TDD-TDD and TDD-FDD combinations.

TABLE 29

| Sub-carrier | UL Sub-carrier | Maximum uplink |
|---|---|---|
| spacing in E-UTRA | spacing for data | transmission timing |
| PCell (kHz) | in PSCell (kHz) | difference (μs) |
| 15 | 15 | 35.21 |
| 15 | 30 | 35.21 |
| 15 | 60 | 34.7 |
| 15 | 120 | 34.7 |

For inter-band TDD-TDD (E-UTRA PCell-PSCell) and inter-band TDD-FDD (E-UTRA PCell-PSCell or PSCell-E-UTRA PCell) combinations, the UE shall meet the requirements in the below table provided that the UE indicates that it is capable of synchronous dual connectivity only within NR one half symbol duration. The below table shows a maximum uplink transmission timing difference requirement for synchronous operation in inter-band TDD-TDD and TDD-FDD combinations within NR one half symbol duration

TABLE 30

| Sub-carrier | UL Sub-carrier | Maximum uplink |
|---|---|---|
| spacing in E-UTRA | spacing for data | transmission timing |
| PCell (kHz) | in PSCell (kHz) | difference (μs) |
| 15 | 15 | 35.21 |
| 15 | 30 | 19.21 |
| 15 | 60 | 9.7 |
| 15 | 120 | 5.7 |

For intra-band FDD-FDD E-UTRA-NR dual connectivity with collocated deployment, the UE shall be capable of handling a maximum uplink transmission timing difference between E-UTRA PCell and PSCell as shown in above table provided the UE indicates that it is capable of asynchronous dual connectivity. For intra-band TDD-TDD E-UTRA-NR dual connectivity with collocated deployment, only synchronous and collocated operation is allowed, thus no uplink transmission timing difference is applicable.

I-1-2. Maximum Receive Timing Difference

A UE shall be capable of handling a relative receive timing difference between subframe timing boundary of E-UTRA PCell and slot timing boundaries of PSCell to be aggregated for E-UTRA-NR dual connectivity.

A UE shall be capable of handling a relative receive timing difference between slot timing boundary of different carriers to be aggregated NR carrier aggregation.

Minimum Requirements for E-UTRA-NR Dual Connectivity is as follows:

For inter-band E-UTRA-NR dual connectivity, the UE shall be capable of handling at least a relative receive timing difference between subframe timing of signal from E-UTRA PCell and slot timing of signal from PSCell at the UE receiver as shown in below table.

The below table shows maximum receive timing difference requirement for asynchronous operation.

TABLE 31

| Sub-carrier spacing in | DL Sub-carrier spacing | Maximum receive |
|---|---|---|
| E-UTRA PCell (kHz) | in PSCell (kHz)Note1 | timing difference (μs) |
| 15 | 15 | 500 |
| 15 | 30 | 250 |
| 15 | 60 | 125 |
| 15 | 120 | 62.5 |

Note1
DL Sub-carrier spacing is min{SCS_{SS}, SCS_{DATA}}.
Note2:
For intra-band FDD-FDD E-UTRA-NR dual connectivity, 120 kHz is not applied.

For inter-band TDD-TDD (E-UTRA PCell-PSCell) and inter-band TDD-FDD (E-UTRA PCell-PSCell or PSCell-E-UTRA PCell) combinations, the UE shall meet the requirements in the above table provided that the UE indicates that it is capable of asynchronous dual connectivity. For inter-band TDD-TDD (E-UTRA PCell-PSCell) and inter-band TDD-FDD (E-UTRA PCell-PSCell or PSCell-E-UTRA PCell) combinations, the UE shall meet the requirements in the below table provided that the UE indicates that it is capable of synchronous dual connectivity only. The UE is assumed that there is no limitation of implementation related to power control and ACG within 33 us.

The below table shows a maximum receive timing difference requirement for synchronous operation in inter-band TDD-TDD and TDD-FDD combinations.

TABLE 32

| Sub-carrier spacing in | DL Sub-carrier spacing | Maximum receive |
|---|---|---|
| E-UTRA PCell (kHz) | in PSCell (kHz)Note1 | timing difference (μs) |
| 15 | 15 | 33 |
| 15 | 30 | 33 |
| 15 | 60 | 33 |
| 15 | 120 | 33 |

Note1
DL Sub-carrier spacing is min{SCS_{SS}, SCS_{DATA}}.

For inter-band TDD-TDD (E-UTRA PCell-PSCell) and inter-band TDD-FDD (E-UTRA PCell-PSCell or PSCell-E-UTRA PCell) combinations, the UE shall meet the requirements in the below table provided that the UE indicates that it is capable of synchronous dual connectivity only within NR one half symbol duration. The below table shows a maximum receive timing difference requirement for synchronous operation in inter-band TDD-TDD and TDD-FDD combinations within NR one half symbol duration.

TABLE 33

| Sub-carrier spacing in | DL Sub-carrier spacing | Maximum receive |
|---|---|---|
| E-UTRA PCell (kHz) | in PSCell (kHz)Note1 | timing difference (μs) |
| 15 | 15 | 33 |
| 15 | 30 | 17 |
| 15 | 60 | 8 |
| 15 | 120 | 4 |

Note1
DL Sub-carrier spacing is min{SCS_{SS}, SCS_{DATA}}.

For intra-band FDD-FDD E-UTRA-NR dual connectivity with collocated deployment, the UE shall be capable of handling at least a relative receive timing difference between subframe timing of signal from E-UTRA PCell and slot timing of signal from PSCell as shown in the table provided the UE indicates that it is capable of asynchronous dual connectivity. For intra-band E-UTRA-NR dual connectivity with collocated deployment, the UE shall be capable of handling at least a relative receive timing difference between subframe timing of signal from E-UTRA PCell and slot timing of signal from PSCell as shown in the below table provided the UE indicates that it is only capable of synchronous dual connectivity.

The below table shows a maximum receive timing difference requirement for synchronous operation in intra-band collocation scenario.

TABLE 34

| Sub-carrier spacing in | DL Sub-carrier spacing | Maximum receive |
|---|---|---|
| E-UTRA PCell (kHz) | in PSCell (kHz)Note1 | timing difference (μs) |
| 15 | 15 | [3] |
| 15 | 30 | [3] |
| 15 | 60 | [3] |

Note1
DL Sub-carrier spacing is min{SCS_{SS}, SCS_{DATA}}.

II. Second Disclosure

The second disclosure provides a behavior and/or requirement of a wireless device related to a maximum receive timing difference (MRTD) and a maximum transmission timing difference (MTTD) in a NR carrier aggregation.

In general, Carrier Aggregation (CA) is operated in synchronized networks. At UE side, maximum received timing difference (MRTD) between from NR PCell NodeB to UE and from NR SCell NodeB to UE is defined as follows. The MRTD can be applied to NR SCells.

MRTD=TAE+Propagation delay difference

TAE (Timing Alignment Error) was specified as follows in TS38.104.

3 us for inter-band NR CA

3 us for intra-band non-contiguous NR CA

260 ns for intra-band contiguous NR CA

Here, the explanation about the TAE is as follows:

This requirement shall apply to frame timing in TX diversity, MIMO transmission, carrier aggregation and their combinations.

Frames of the NR signals present at the BS transmitter antenna connectors or TAB connectors are not perfectly aligned in time. The RF signals present at the BS transmitter antenna connectors or transceiver array boundary may experience certain timing differences in relation to each other.

The TAE is specified for a specific set of signals/transmitter configuration/transmission mode.

For BS type 1-C, the TAE is defined as the largest timing difference between any two signals belonging to different antenna connectors for a specific set of signals/transmitter configuration/transmission mode.

For BS type 1-H, the TAE is defined as the largest timing difference between any two signals belonging to TAB connectors belonging to different transmitter groups at the transceiver array boundary, where transmitter groups are associated with the TAB connectors in the transceiver unit array corresponding to TX diversity, MIMO transmission, carrier aggregation for a specific set of signals/transmitter configuration/transmission mode.

Minimum requirement for BS type 1-C and 1-H

For MIMO or TX diversity transmissions, at each carrier frequency, TAE shall not exceed 65 ns.

For intra-band contiguous carrier aggregation, with or without MIMO or TX diversity, TAE shall not exceed 260 ns.

For intra-band non-contiguous carrier aggregation, with or without MIMO or TX diversity, TAE shall not exceed 3 μs.

For inter-band carrier aggregation, with or without MIMO or TX diversity, TAE shall not exceed 3 μs.

Propagation delay difference can be calculated with following assumption of distance difference between from NR PCell NodeB to UE and from NR SCell NodeB to UE for deployment scenarios.

Frequency Range 1(FR1): below 6 GHz

Frequency Range 2(FR2): mmWave

Distance difference: 9 km
FR1(PCell) & FR1(SCell), FR1(SCell) & FR1(SCell)
FR1(PCell) & FR2(SCell), FR1(SCell) & FR2(SCell),

Distance difference: 1.5 km
FR2(PCell) & FR2(SCell), FR2(SCell) & FR2(SCell)

For simple explanation, combination of PCell and SCell is assumed below. However it can be applied for multiple SCells.

Propagation Delay Difference

30 us=9 km/(3*108 m/s) for 9 km(Distance difference)

5 us=1.5 km/(3*108 m/s) for 1.5 km(Distance difference)

Regarding TAE and Propagation delay difference, MRTD can be 33 us for distance difference of 9 km and 8 us for distance difference of 1.5 km.

In general, Maximum Transmission Timing Difference (MTTD) is defined as follows.

MTTD=MRTD+Transmission timing Error+Uncertainty of receiving time

Transmission timing Error=Transmission timing Error for PCell+Transmission timing Error for SCell

Uncertainty of receiving time=Uncertainty of receiving time for PCell+Uncertainty of receiving time for SCell

Transmission timing error was specified differently depending on SubCarrier Spacing (SCS) for NR.

In NR, SCS was defined for Data and Synchronization Signal (SS) as follows.

TABLE 35

| | |
|---|---|
| DATA | SS |

| SCS | FR1 | FR2 | FR1 | FR2 |
|---|---|---|---|---|
| 15 kHz | ✓ | | ✓ | |
| 30 kHz | ✓ | | ✓ | |
| 60 kHz | ✓ | ✓ | | |
| 120 kHz | | ✓ | | ✓ |
| 240 kHz | | | | ✓ |

The below table shows Tₑ Timing Error Limit.

TABLE 36

| Frequency | SCS of SSB | SCS of uplink | |
|---|---|---|---|
| Range | signals (KHz) | signals s(KHz) | Tₑ |
| FR1 | 15 | 15 | [12]*64*T_{c} |
| | | 30 | [10]*64*T_{c} |
| | | 60 | [10]*64*T_{c} |
| | 30 | 15 | [8]*64*T_{c} |
| | | 30 | [8]*64*T_{c} |
| | | 60 | [7]*64*T_{c} |
| FR2 | 120 | 60 | [3.5]*64*T_{c} |
| | | 120 | [3.5]*64*T_{c} |
| | 240 | 60 | [3]*64*T_{c} |
| | | 120 | [3]*64*T_{c} |

Here, T_{c} is the basic timing unit. Also, T_{c}=Ts/64, Ts=1/(15000*2048) sec. Uncertainty of receiving time can be different depending on applied SCS.

TABLE 37

| | Tᵤ: uncertainty of receiving time |
|---|---|
| DATA SCS | (Ts) for PCell or SCell |
| 15 | 10 |
| 30 | 5 |
| 60 | 2.5 |
| 120 | 1.25 |

For Transmission timing Error+Uncertainty of receiving time, maximum value: 44Ts(1.43 us)=[12]*64*Tc+[12]*64*Tc+10Ts+10Ts for FR1(PCell)+FR1(Scell)

minimum value: 8.5Ts(0.28 us)=[3]*64*Tc+[3]*64*Tc+1.25Ts+1.25Ts for FR2(PCell)+FR1(Scell)

One value can be use with representative value to avoid complicated requirement since the value is very small comparing MRTD in variance aspect. Regarding co-operation with E-UTRA (LTE), it is proposed to use 2.21 us for the transmission timing Error+uncertainty of receiving time.

Based on the TAE and propagation delay difference, corresponding MRTD can be defined.

For inter-band NR CA
When UE is configured as NR CA in FR1: MRTD=33 μs
When UE is configured as NR CA in FR2: MRTD=8 μs
When UE is configured as NR CA in mixed FR1 & FR2: MRTD=33 μs

For intra-band non-contiguous NR CA
When UE is configured as NR CA in FR1: MRTD=33 μs
When UE is configured as NR CA in FR2: MRTD=8 μs

The MRTD requirements should be applied for when one SCell is configured and when multiple SCells are configured.

For NR CA MTTD, the requirement is not necessary for intra-band contiguous NR CA since it is meaningless regarding simultaneous transmission, however it is necessary for intra-band non-contiguous NR CA and inter-band NR CA like LTE CA. The MTTD can be addressed by adding 2.21 μs to MRTD like EN-DC.

For inter-band NR CA
When UE is configured as NR CA in FR1: MTTD=35.21 μs
When UE is configured as NR CA in FR2: MTTD=10.21 μs
When UE is configured as NR CA in mixed FR1 & FR2: MTTD=35.21 μs

For intra-band non-contiguous NR CA

When UE is configured as NR CA in FR1: MTTD=35.21 μs

When UE is configured as NR CA in FR2: MTTD=10.21 μs

In addition to MTTD, like LTE CA, related UE behaviour needs to be specified if after timing adjusting due to received TA command the uplink transmission timing difference between PCell and SCell exceeds the maximum value the UE can handle. The UE behaviour can reuse LTE CA with only replacement of MTTD.

In LTE CA, related requirement for Maximum Transmission Timing Difference in Carrier Aggregation is specified as follows:

A UE shall be capable of handling a relative received time difference between the PCell and SCell to be aggregated in inter-band CA and intra-band non-contiguous CA.

Minimum Requirements for Interband Carrier Aggregation is as follows:

The UE shall be capable of handling at least a relative received timing difference between the subframe timing boundaries of the signals received from the PCell and the SCell at the UE receiver of up to 30.26 μs when one SCell is configured.

When two, three, or four SCells are configured, the UE shall be capable of handling at least a relative propagation delay difference between the subframe timing boundaries of the signals received from any pair of the serving cells (PCell and the SCells) at the UE receiver of up to 30.26

The UE shall be capable of handling a maximum uplink transmission timing difference between the pTAG and the sTAG of at least 32.47 μs provided that the UE is:
configured with inter-band CA and
configured with the pTAG and the sTAG,

A UE configured with pTAG and sTAG may stop transmitting on the SCell if after timing adjusting due to received TA command the uplink transmission timing difference between PCell and SCell exceeds the maximum value the UE can handle as specified above.

The UE shall be capable of handling a maximum uplink transmission timing difference between the pTAG and any of the two sTAGs or between the two sTAGs of at least 32.47 μs provided that the UE is:
configured with inter-band CA and
configured with the two sTAGs,

A UE configured with two sTAGs may stop transmitting on the SCell if after timing adjusting due to received TA command the uplink transmission timing difference between SCell in one sTAG and SCell in other sTAG exceeds the maximum value the UE can handle as specified above.

Minimum Requirements for Intraband non-contiguous Carrier Aggregation is as follows:

The UE shall be capable of handling at least a relative received timing difference between the subframe timing boundaries of the signals received from the PCell and the SCell at the UE receiver of up to 30.26 μs.

The UE shall be capable of handling a maximum uplink transmission timing difference between the pTAG and the sTAG of at least 32.47 μs provided that the UE is:
configured with intra-band non-contiguous CA and
configured with the pTAG and the sTAG,

A UE configured with pTAG and sTAG may stop transmitting on the SCell if after timing adjusting due to received TA command the uplink transmission timing difference between PCell and SCell exceeds the maximum value the UE can handle as specified above.

Proposal 1: For inter-band NR CA, define MRTD with 33 μs for FR1, 8 μs for FR2 and 33 μs for mixed FR1 and FR2.

Proposal 2: For intra-band non-contiguous NR CA, define MRTD with 33 μs for FR1 and 8 μs for FR2.

Proposal 3: For intra-band contiguous NR CA, don not define MRTD for FR1 and FR2.

Proposal 4: For inter-band NR CA, define MTTD with 35.21 μs for FR1, 10.21 μs for FR2 and 35.21 μs for mixed FR1 and FR2.

Proposal 5: For intra-band non-contiguous NR CA, define MTTD with 35.21 μs for FR1 and 10.21 μs for FR2.

Proposal 6: For intra-band contiguous NR CA, don not define MTTD for FR1 and FR2.

Proposal 7: Define UE behaviour related to NR CA MTTD for inter-band NR CA and intra-band non-contiguous NR CA.

Based on the proposed MRTD, MTTD and UE behaviour, we propose related requirement for NR CA with underline as follows.

II-1. Modification to 3GPP Standard Based on the First Disclosure

II-1-1. Maximum Transmission Timing Difference

A UE shall be capable of handling a relative transmission timing difference between subframe timing boundary of E-UTRA PCell and slot timing boundaries of PSCell to be aggregated EN-DC.

A UE shall be capable of handling a relative transmission timing difference between slot timing boundary of different carriers to be aggregated in inter-band NR CA and intra-band non-contiguous NR CA.

Minimum Requirements for inter-band EN-DC is as follows:

The UE shall be capable of handling a maximum uplink transmission timing difference between E-UTRA PCell and PSCell as shown in the below table. The requirements for asynchronous EN-DC are applicable for E-UTRA TDD-NR TDD, E-UTRA FDD-NR FDD, E-UTRA FDD-NR TDD and E-UTRA TDD-NR FDD inter-band asynchronous EN-DC.

Below table shows a maximum uplink transmission timing difference requirement for asynchronous EN-DC

TABLE 38

| Sub-carrier | UL Sub-carrier | Maximum uplink |
|---|---|---|
| spacing in E-UTRA | spacing for data | transmission timing |
| PCell (kHz) | in PSCell (kHz) | difference (μs) |
| 15 | 15 | 500 |
| 15 | 30 | 250 |
| 15 | 60 | 125 |
| 15 | 120Note1 | 62.5 |

Note1
For E-UTRA FDD- NR FDD and E-UTRA TDD- NR TDD intra-band EN-DC, 120 kHz is not applied.

The UE shall be capable of handling a maximum uplink transmission timing difference between E-UTRA PCell and PSCell as shown in the below table provided that the UE indicates that it is capable of synchronous EN-DC. The requirements for synchronous EN-DC are applicable for E-UTRA TDD-NR TDD, E-UTRA TDD-NR FDD and E-UTRA FDD-NR TDD inter-band EN-DC. Below table shows a maximum uplink transmission timing difference requirement for inter-band synchronous EN-DC.

TABLE 39

| Sub-carrier | UL Sub-carrier | Maximum uplink |
|---|---|---|
| spacing in E-UTRA | spacing for data | transmission timing |
| PCell (kHz) | in PSCell (kHz) | difference (μs) |
| 15 | 15 | 35.21 |
| 15 | 30 | 35.21 |
| 15 | 60 | 35.21 |
| 15 | 120 Note1 | 35.21 |

Note1:
For E-UTRA FDD- NR FDD and E-UTRA TDD- NR TDD intra-band EN-DC, 120 kHz is not applied.

Minimum Requirements for intra-band EN-DC is as follows: For intra-band EN-DC, only collocated deployment is applied.

The UE shall be capable of handling a maximum uplink transmission timing difference between E-UTRA PCell and PSCell as shown in Table 7.5.2-1 provided the UE indicates that it is capable of asynchronous EN-DC. The requirements for asynchronous EN-DC are applicable for E-UTRA FDD-NR FDD and E-UTRA TDD-NR TDD intra-band asynchronous EN-DC.

No uplink transmission timing difference is applicable for synchronous EN-DC.

Minimum Requirements for inter-band NR CA is proposed as follows:

The UE shall be capable of handling a maximum uplink transmission timing difference between the pTAG and the sTAG of at least 35.21 μs for FR1, 10.21 μs for FR2 and 35.21 μs for mixed FR1 and FR2 provided that the UE is:
configured with inter-band CA and
configured with the pTAG and the sTAG,

A UE configured with pTAG and sTAG may stop transmitting on the SCell if after timing adjusting due to received TA command the uplink transmission timing difference between PCell and SCell exceeds the maximum value the UE can handle as specified above.

The UE shall be capable of handling a maximum uplink transmission timing difference between the pTAG and any of the two sTAGs or between the two sTAGs of at least 35.21 μs for FR1, 10.21 μs for FR2 and 35.21 μs for mixed FR1 and FR2 provided that the UE is:
configured with inter-band CA and
configured with the two sTAGs,

A UE configured with two sTAGs may stop transmitting on the SCell if after timing adjusting due to received TA command the uplink transmission timing difference between SCell in one sTAG and SCell in other sTAG exceeds the maximum value the UE can handle as specified above.

Minimum Requirements for intra-band non-contiguous NR CA is proposed as follows:

The UE shall be capable of handling a maximum uplink transmission timing difference between the pTAG and the sTAG of at least 35.21 μs for FR1 and 10.21 μs for FR2 provided that the UE is:
configured with inter-band CA and
configured with the pTAG and the sTAG,

A UE configured with pTAG and sTAG may stop transmitting on the SCell if after timing adjusting due to received TA command the uplink transmission timing difference between PCell and SCell exceeds the maximum value the UE can handle as specified above.

The UE shall be capable of handling a maximum uplink transmission timing difference between the pTAG and any of the two sTAGs or between the two sTAGs of at least 35.21 μs for FR1 and 10.21 μs for FR2 provided that the UE is:
configured with inter-band CA and
configured with the two sTAGs,

A UE configured with two sTAGs may stop transmitting on the SCell if after timing adjusting due to received TA command the uplink transmission timing difference between SCell in one sTAG and SCell in other sTAG exceeds the maximum value the UE can handle as specified above.

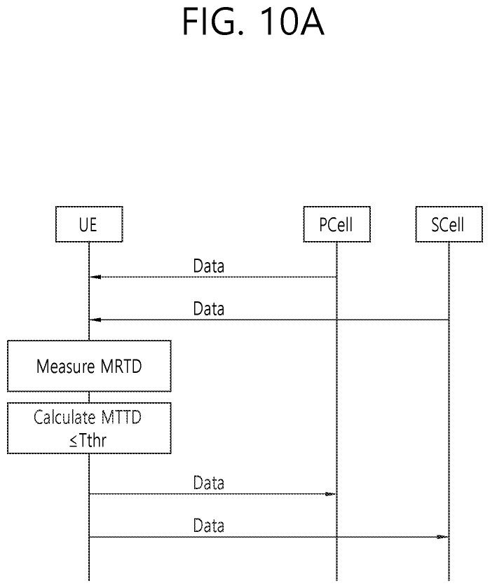

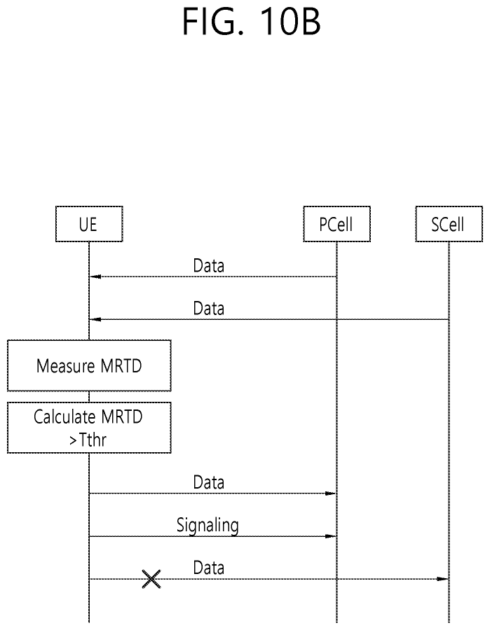

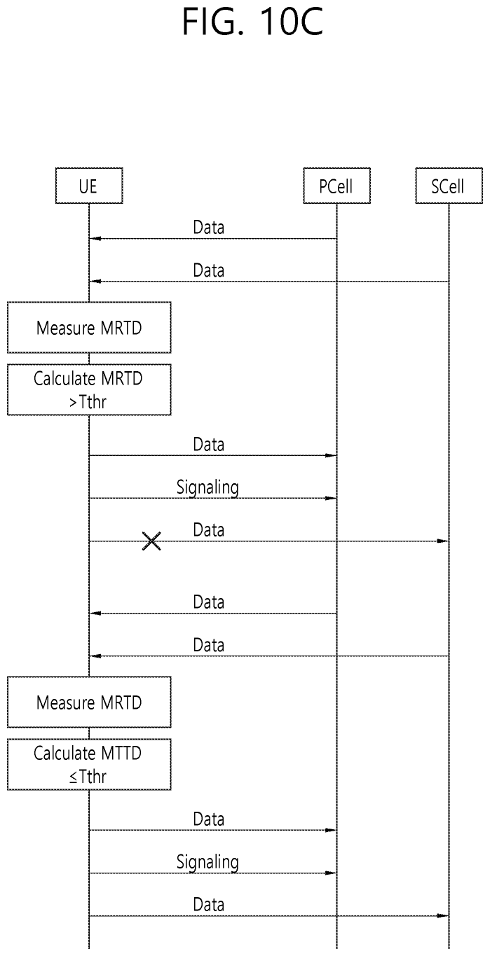

In addition, for stopping transmission under above condition, Network needs to know it once measured MTTD is larger than the requirement (e.g. 35.21 us for FR1 and 10.21 us for FR2). So, it is proposed that that a signaling is needed to indicate from UE to Network(NodeB) for Network's proper scheduling of CA when UE stops transmission on the SCell as shown in FIG. 10b.

And/Or we propose that if MRTD is larger than the requirement in NR CA (e.g. 33 μs for FR1, 8 μs for FR2 and 33 μs for mixed FR1 and FR2 in 7.6 below), a UE configured with two sTAGs may stop transmitting on the SCell. So, a signaling is needed to indicate from UE to Network (NodeB) when UE stops transmission on the SCell.

FIG. 10a Shows an Example Case of MTTD<=Tthr, FIG. 10b Shows an Example Case of MTTD>Tthr and FIG. 10c Shows an Example Case of MTTD>Tthr and MTTD<=Tthr.

Here, Tthr is the minimum requirement of MTTD (e.g. 35.21 us for FR1 and 10.21 us for FR2). From FIG. 10c, it is proposed that signaling is also needed to indicate to Network(NodeB) re-transmission on SCell when MTTD is equal to or smaller than the requirement.

II-1-2. Maximum Receive Timing Difference

A UE shall be capable of handling a relative receive timing difference between subframe timing boundary of E-UTRA PCell and slot timing boundaries of PSCell to be aggregated for EN-DC.

A UE shall be capable of handling a relative receive timing difference between slot timing boundary of different carriers to be aggregated in inter-band NR CA and intra-band non-contiguous NR CA.

Minimum Requirements for inter-band EN-DC is as follows:

The UE shall be capable of handling at least a relative receive timing difference between subframe timing of signal from E-UTRA PCell and slot timing of signal from PSCell at the UE receiver as shown in the below table. The requirements for asynchronous EN-DC are applicable for E-UTRA TDD-NR TDD, E-UTRA FDD-NR FDD, E-UTRA FDD-NR TDD and E-UTRA TDD-NR FDD inter-band EN-DC.

Below table shows Maximum receive timing difference requirement for asynchronous EN-DC.

TABLE 40

| Sub-carrier spacing in | DL Sub-carrier spacing | Maximum receive |
|---|---|---|
| E-UTRA PCell (kHz) | in PSCell (kHz)Note1 | timing difference (μs) |
| 15 | 15 | 500 |
| 15 | 30 | 250 |
| 15 | 60 | 125 |
| 15 | 120 | 62.5 |

Note1
DL Sub-carrier spacing is min{SCSSS, SCSDATA}.
Note2:
For E-UTRA FDD- NR FDD and E-UTRA TDD- NR TDD intra-band EN-DC, 120 kHz is not applied.

The UE shall be capable of handling at least a relative receive timing difference between subframe timing of signal from E-UTRA PCell and slot timing of signal from PSCell at the UE receiver as shown in the below table provided that the UE indicates that it is capable of synchronous EN-DC. The requirements for synchronous EN-DC are applicable for E-UTRA TDD-NR TDD, E-UTRA TDD-NR FDD and E-UTRA FDD-NR TDD inter-band EN-DC.

Below table shows Maximum receive timing difference requirement for inter-band synchronous EN-DC.

TABLE 41

| Sub-carrier spacing in | DL Sub-carrier spacing | Maximum receive |
|---|---|---|
| E-UTRA PCell (kHz) | in PSCell (kHz)Note1 | timing difference (μs) |
| 15 | 15 | 33 |
| 15 | 30 | |
| 15 | 60 | |
| 15 | 120 | |

Note1
DL Sub-carrier spacing is min{SCS_{SS}, SCS_{DATA}}.
Note2:
For E-UTRA FDD- NR FDD and E-UTRA TDD- NR TDD intra-band EN-DC, 120 kHz is not applied.

Minimum Requirements for intra-band EN-DC is as follows: For intra-band EN-DC, only collocated deployment is applied.

The UE shall be capable of handling at least a relative receive timing difference between subframe timing of signal from E-UTRA PCell and slot timing of signal from PSCell as shown in the below table provided the UE indicates that it is capable of asynchronous EN-DC. The requirements for asynchronous EN-DC are applicable for E-UTRA FDD-NR FDD and E-UTRA TDD-NR TDD intra-band EN-DC.

The UE shall be capable of handling at least a relative receive timing difference between subframe timing of signal from E-UTRA PCell and slot timing of signal from PSCell as shown in the below table provided the UE indicates that it is only capable of synchronous EN-DC. The requirements for synchronous EN-DC are applicable for E-UTRA TDD-NR TDD and E-UTRA FDD-NR FDD intra-band EN-DC.

Below table shows Maximum receive timing difference requirement for intra-band synchronous EN-DC.

TABLE 42

| Sub-carrier spacing in | DL Sub-carrier spacing | Maximum receive |
|---|---|---|
| E-UTRA PCell (kHz) | in PSCell (kHz) Note1 | timing difference (μs) |
| 15 | 15 | 3 |
| 15 | 30 | 3 |
| 15 | 60 | 3 |

Note1:
DL Sub-carrier spacing is min{SCS_{SS}, SCS_{DATA}}.

Minimum Requirements for inter-band NR CA is proposed as follows: The UE shall be capable of handling at least a relative received timing difference between the slot timing boundaries of the signals received from the PCell and the SCell at the UE receiver of up to 33 μs for FR1, 8 μs for FR2 and 33 μs for mixed FR1 and FR2 when one SCell is configured.

When multiple SCells are configured, the UE shall be capable of handling at least a relative propagation delay difference between the slot timing boundaries of the signals received from any pair of the serving cells (PCell and the SCells) at the UE receiver of up to 33 μs for FR1, 8 μs for FR2 and 33 μs for mixed FR1 and FR2.

Minimum Requirements for intra-band non-contiguous NR CA is proposed as follows:

The UE shall be capable of handling at least a relative received timing difference between the slot timing boundaries of the signals received from the PCell and the SCell at the UE receiver of up to 33 μs for FR1 and 8 μs for FR2 when one SCell is configured.

When multiple SCells are configured, the UE shall be capable of handling at least a relative propagation delay difference between the slot timing boundaries of the signals received from any pair of the serving cells (PCell and the SCells) at the UE receiver of up to 33 μs for FR1 and 8 μs for FR2.

The above-described embodiments of the present invention may be implemented by use of various means. For example, the embodiments of the present invention may be implemented by hardware, firmware, and software or a combination thereof. A detailed description thereof will be provided with reference to drawings.

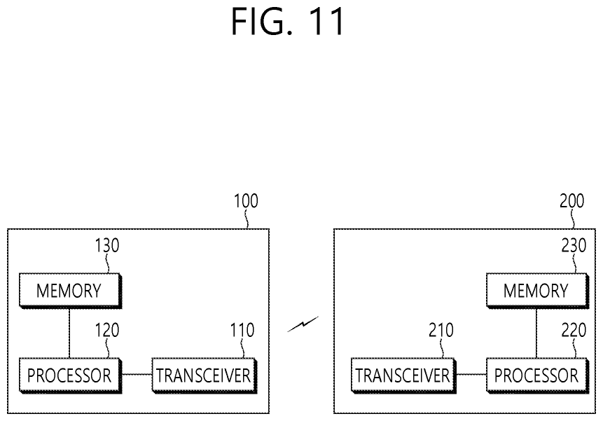

FIG. 11 is a Block Diagram Illustrating a Wireless Device and a Base Station, by which the Disclosure of this Specification can be Implemented.

Referring to FIG. 11, a wireless device 100 and a base station 200 may implement the disclosure of this specification.

The wireless device 100 includes a processor 101, a memory 102, and a transceiver 103. Likewise, the base station 200 includes a processor 201, a memory 202, and a transceiver 203. The processors 101 and 201, the memories 102 and 202, and the transceivers 103 and 203 may be implemented as separate chips, or at least two or more blocks/functions may be implemented through one chip.

Each of the transceivers 103 and 203 includes a transmitter and a receiver. When a particular operation is performed, either or both of the transmitter and the receiver may operate. Each of the transceivers 103 and 203 may include one or more antennas for transmitting and/or receiving a radio signal. In addition, each of the transceivers 103 and 203 may include an amplifier configured for amplifying a Rx signal and/or a Tx signal, and a band pass filter for transmitting a signal to a particular frequency band.

Each of the processors 101 and 201 may implement functions, procedures, and/or methods proposed in this specification. Each of the processors 101 and 201 may include an encoder and a decoder. For example, each of the processors 101 and 202 may perform operations described above. Each of the processors 101 and 201 may include an application-specific integrated circuit (ASIC), a different chipset, a logic circuit, a data processing device, and/or a converter which converts a base band signal and a radio signal into each other.

Each of the memories 102 and 202 may include a Read-Only Memory (ROM), a Random Access Memory (RAM), a flash memory, a memory card, a storage medium, and/or any other storage device.

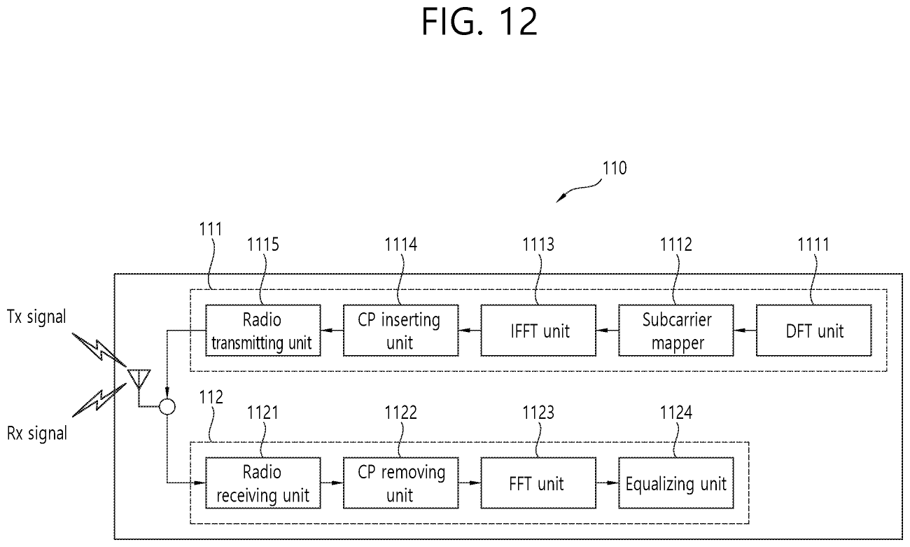

FIG. 12 is a Detailed Block Diagram Illustrating a Transceiver of the Wireless Device Shown in FIG. 11.

Referring to FIG. 12, a transceiver 110 includes a transmitter 111 and a receiver 112. The transmitter 111 includes a Discrete Fourier Transform (DFT) unit 1111, a subcarrier mapper 1112, an IFFT unit 1113, a CP insertion unit 1114, a wireless transmitter 1115. In addition, the transceiver 1110 may further include a scramble unit (not shown), a modulation mapper (not shown), a layer mapper (not shown), and a layer permutator, and the transceiver 110 may be disposed in front of the DFT unit 1111. That is, in order to prevent a peak-to-average power ratio (PAPR) from increasing, the transmitter 111 may transmit information to pass through the DFT unit 1111 before mapping a signal to a subcarrier. A signal spread (or pre-coded for the same meaning) by the DFT unit 111 is subcarrier-mapped by the subcarrier mapper 1112, and then generated as a time domain signal by passing through the IFFT unit 1113.

The DFT unit 111 performs DFT on input symbols to output complex-valued symbols. For example, if Ntx symbols are input (here, Ntx is a natural number), a DFT size may be Ntx. The DFT unit 1111 may be called a transform precoder. The subcarrier mapper 1112 maps the complex-valued symbols to subcarriers of a frequency domain. The complex-valued symbols may be mapped to resource elements corresponding to a resource block allocated for data transmission. The subcarrier mapper 1112 may be called a resource element mapper. The IFFT unit 113 may perform IFFT on input symbols to output a baseband signal for data, which is a time-domain signal. The CP inserter 1114 copies a rear portion of the baseband signal for data and inserts the copied portion into a front part of the baseband signal. The CP insertion prevents Inter-Symbol Interference (ISI) and Inter-Carrier Interference (ICI), and therefore, orthogonality may be maintained even in multi-path channels.

Meanwhile, the receiver 112 includes a wireless receiver 1121, a CP remover 1122, an FFT unit 1123, and an equalizer 1124, and so on. The wireless receiver 1121, the CP remover 1122, and the FFT unit 1123 of the receiver 112 performs functions inverse to functions of the wireless transmitter 1115, the CP inserter 1114, and the IFFT unit 113 of the transmitter 111. The receiver 112 may further include a demodulator.

1. A method for transceiving a signal, the method performed by a wireless terminal and comprising:
transmitting uplink signals to a first cell and a second cell,
wherein the first cell and the second cell are configured for a dual connectivity,
wherein the first cell is an evolved universal terrestrial radio access (E-UTRA) based cell,
wherein the second cell is a new radio access technology (NR) based cell,
wherein a maximum transmission timing difference (MTTD) between the first cell and the second cell is 35.21 μs for all of uplink subcarrier spacings (SCSs) of the second cell, and
wherein the all of the uplink SCSs of the second cell include 15 kHz, 30 kHz, 60 kHz and 120 kHz.

2. The method of claim 1, further comprising:
handling the MTTD of 35.21 μs.

3. The method of claim 1, further comprising:
receiving downlink signals from the first cell and the second cell,
wherein a maximum receive timing difference (MRTD) between the first cell and the second cell is 33 μs for all of downlink SCSs of the second cell, and
wherein the all of the downlink SCSs of the second cell include 15 kHz, 30 kHz, 60 kHz and 120 kHz.

4. The method of claim 1, further comprising:
handling the MRTD of 33 μs.

5. The method of claim 1, wherein the EN-DC is an inter-band EN-DC.

6. The method of claim 1, wherein the EN-DC is a synchronous EN-DC.

7. A wireless terminal for transceiving a signal, the wireless terminal comprising:
a transceiver; and
a processor operatively connected to the transceiver thereby controlling the transceiver to transmit uplink signals to a first cell and a second cell,
wherein the first cell and the second cell are configured for a dual connectivity,
wherein the first cell is an evolved universal terrestrial radio access (E-UTRA) based cell,
wherein the second cell is a new radio access technology (NR) based cell,
wherein a maximum transmission timing difference (MTTD) between the first cell and the second cell is 35.21 μs for all of uplink subcarrier spacings (SCSs) of the second cell, and
wherein the all of the uplink SCSs of the second cell include 15 kHz, 30 kHz, 60 kHz and 120 kHz.

8. The wireless terminal of claim 7, wherein the processor is configured to:
handle the MTTD of 35.21 μs.

9. The wireless terminal of claim 7, wherein the processor is configured to:
control the transceiver to receive downlink signals from the first cell and the second cell,
wherein a maximum receive timing difference (MRTD) between the first cell and the second cell is 33 μs for all of downlink SCSs of the second cell, and
wherein the all of the downlink SCSs of the second cell include 15 kHz, 30 kHz, 60 kHz and 120 kHz.

10. The wireless terminal of claim 7, wherein the processor is configured to:
handle the MRTD of 33 μs.

11. The wireless terminal of claim 7, wherein the EN-DC is an inter-band EN-DC.

12. The wireless terminal of claim 7, wherein the EN-DC is a synchronous EN-DC.

13. A controller for wireless terminal comprising:
a processor configured to transmit, via a transceiver, uplink signals to a first cell and a second cell,
wherein the first cell and the second cell are configured for a dual connectivity,
wherein the first cell is an evolved universal terrestrial radio access (E-UTRA) based cell,
wherein the second cell is a new radio access technology (NR) based cell,
wherein a maximum transmission timing difference (MTTD) between the first cell and the second cell is 35.21 μs for all of uplink subcarrier spacings (SCSs) of the second cell, and
wherein the all of the uplink SCSs of the second cell include 15 kHz, 30 kHz, 60 kHz and 120 kHz.

14. The controller of claim 13, wherein the processor is configured to:
handle the MTTD of 35.21 μs.

15. The controller of claim 13, wherein the processor is configured to:
receive downlink signals from the first cell and the second cell,
wherein a maximum receive timing difference (MRTD) between the first cell and the second cell is 33 μs for all of downlink SCSs of the second cell, and
wherein the all of the downlink SCSs of the second cell include 15 kHz, 30 kHz, 60 kHz and 120 kHz.
